(19) United States
(12) Patent Application Publication
(10) Pub. No.: US 2011/0153396 A1
(43) Pub. Date: Jun. 23, 2011

(54) METHOD AND SYSTEM FOR PROCESSING ON-LINE TRANSACTIONS INVOLVING A CONTENT OWNER, AN ADVERTISER, AND A TARGETED CONSUMER

(76) Inventors: Andrew Marcuvitz, Lincoln, MA (US); Andrew Prihodko, Lincoln, MA (US); Sharon A. Peyer, Lincoln, MA (US)

(21) Appl. No.: 12/644,553

(22) Filed: Dec. 22, 2009

(51) Int. Cl. G06Q 30/00; H04L 9/32; G06F 21/00; G06Q 20/00

(52) U.S. Cl. 705/14.2; 705/14.19; 705/14.44; 726/7

(57) ABSTRACT

Systems and methods of delivering and accessing information such as targeted advertisements and other information content in a computer network environment that increase the efficiency of services provided by advertisers, while enhancing the economics of information content owners. The system implements a triangular economic transaction enabling negotiated transactions involving an information content owner, an advertiser, and a consumer. During the transactions between the respective parties, the information content owner is in control over terms of sale for its information content, the advertiser is in control over terms of its advertising campaign, and the consumer maintains control over personal profile information upon which the targeting of advertisements is based. The system allows the consumer to view targeted advertisements or any desired information content at a computer or computerized device on his or her own schedule, while maintaining a desired level of on-line privacy.

### CROSS REFERENCE TO RELATED APPLICATIONS

Not applicable

### STATEMENT REGARDING FEDERALLY SPONSORED RESEARCH OR DEVELOPMENT

Not applicable

### FIELD OF THE INVENTION

The present invention relates generally to systems and methods of delivering and accessing information targeted to a user in a computer network environment, and more specifically to a system and method of enabling, over a distributed, networked computer system, negotiated transactions between an information content owner, an advertiser, and a consumer, in which the consumer can earn electronic credit for viewing targeted advertisements delivered by the advertiser and use the earned credit to access information content from the information content owner. During the transactions between the respective parties, the information content owner is in control over terms of sale for its information content, the advertiser is in control over terms of its advertising campaign, and the consumer is in control over whether and when he or she views the targeted advertisements and the information content, while maintaining control over his or her personal profile information upon which the targeting of advertisements is at least partially based.

### BACKGROUND OF THE INVENTION

Systems and methods of delivering and accessing information such as advertisements (the “ads”) targeted to a user (the “consumer”) are known that may be employed to compensate consumers for their time and attention expended while viewing the targeted ads. For example, a known system for delivering and accessing ads targeted to a consumer includes a consumer computer and an attention brokerage server, both of which are connected to a computer network. This known system for delivering and accessing targeted ads provides for direct payment to the consumer for paying adequate attention to an ad, which can be provided to the consumer computer by the attention brokerage server over the computer network. Specifically, the attention brokerage server receives, over the network, ad targeting criteria from an advertiser and personal profile information from the consumer computer. By matching the consumer's personal profile information against the advertiser's ad targeting criteria, the attention brokerage server can determine what ad(s) might be of interest to the consumer. Having identified an ad targeted to the interests of the consumer, the attention brokerage server forwards a so-called “CyberCoin” to the consumer computer over the network. The CyberCoin, which is displayed on the consumer computer as an icon, reflects a payment or other incentive that the consumer may receive for viewing the targeted ad.

Using the consumer computer, the consumer can “click on” the CyberCoin icon to initiate automatic retrieval of the targeted ad from the attention brokerage server, or from a network address of the advertiser. The attention brokerage server typically requires some level of consumer interaction with the targeted ad on the consumer computer to assure that the consumer has paid adequate attention to the ad before he or she is compensated for viewing the ad. Based on data generated by the consumer computer, the attention brokerage server determines whether the consumer's interaction with the targeted ad was adequate enough to warrant compensation. Having determined that the consumer's interaction with the targeted ad was adequate, the attention brokerage server compensates the consumer using a financial clearinghouse to transfer electronic cash over the network to an account of the consumer. The consumer can then use that electronic cash to pay an information provider for entertainment or other information that he or she wishes to access, such as a movie, a television program, a song, a magazine, a newspaper article, or a research report. In this way, the sponsorship of desired entertainment or other information becomes unlinked from the entertainment or information content, allowing advertisers to target their ads more accurately and efficiently to particular consumers who might be interested in viewing such ads.

One drawback of the above-described system for delivering and accessing advertisements targeted to a user over a computer network is that, while it provides a mechanism for advertisers to more accurately and efficiently target their ads to particular consumers, it offers little to enhance the economics of information providers who wish to sell entertainment or other information to consumers. For example, although the known system for delivering and accessing targeted ads described above allows a consumer to use his or her earned electronic cash to pay an information provider for desired entertainment or information content, it provides no mechanisms for authorizing any payment transactions involving the information provider and the consumer, for tracking the available electronic cash of the consumer, or for assuring that proper payment is ultimately provided to the information provider in exchange for the entertainment or information content provided to the consumer.

In addition, the above-described system can introduce inefficiencies that may inhibit an economic transaction from ever being consummated. For example, the known system described above implements a traditional “bilateral economic transaction”, in which two parties mutually agree to exchange two things, one of which is typically an amount of money. For such a bilateral economic transaction to occur voluntarily, both parties to the transaction typically have to assess the value parity of what they are getting, versus what they are giving up. In the above-described system, the consumer has to assess the monetary value of their attention as a vehicle for receiving compensation from the advertiser.

However, although the advertiser may have considerable expertise in the area of assessing the monetary value of a consumer's attention, the typical consumer generally does not have such expertise. Indeed, in the above-described system, the consumer may disagree with the monetary value placed on their attention by the advertiser, and may become upset to discover that their neighbor's attention is deemed by the advertiser to be worth more than their own. The consumer may also have to make an assessment of the monetary value of their attention without knowing the price of any entertainment or information content they may wish to access in return. It may therefore become necessary for the consumer to acquire a sense of the worth of their attention over time to determine whether they would gain satisfaction in any future transaction with the advertiser.

Moreover, the information content owner, who, in the above-described system, is not a party to the bilateral economic transaction, may wish to offer access to entertainment or information content to different groups of consumers at different prices. In the above-described system, the consumer may become upset to discover that the price they must pay for desired entertainment or information content is different from the price of the content offered to consumers in another group. Collectively, these effects can inhibit any economic transactions between the consumer, the advertiser, and the information content owner from occurring, and can distort the transaction prices at which the consumer, the advertiser, and the information content owner would otherwise be satisfied.

It would therefore be desirable to have an improved system and method of delivering and accessing information targeted to a user in a computer network environment that avoids one or more of the drawbacks of known systems for delivering and accessing such targeted information.

### BRIEF SUMMARY OF THE INVENTION

In accordance with the present invention, systems and methods of delivering and accessing information such as targeted advertisements (the “ads”) and other information content in a computer network environment are disclosed that increase the efficiency of services provided by advertisers, while enhancing the economics of information content owners. The presently disclosed systems and methods can be used to implement a so-called “triangular economic transaction” through which the information content owners can effectively negotiate sales of their content in transactions involving both the advertisers and content consumers. During each transaction leading to a sale of content, the information content owners are in control over terms of sale for the content, the advertisers are in control over terms of their advertising campaigns, and the consumers are in control over whether and when they consume (e.g., view and/or listen to) the targeted advertisements and the information content, while maintaining control over their personal profile information upon which the targeting of ads is at least partially based. The presently disclosed system and method also provides consumers with an enhanced viewing experience that allows them to consume targeted ads or other desired information content at a personal computer or any other suitable computerized device on their own schedules, while maintaining a desired level of on-line privacy.

By using the presently disclosed systems and methods to implement a triangular economic transaction, an advertiser, an information content owner, and a consumer can focus on making assessments regarding the transaction within their own spheres of expertise. For example, the advertiser may make an assessment regarding the price they are willing to pay for the attention of the consumer, according to their own specifications. Further, the information content owner may make an assessment regarding what price they will demand for their entertainment or information content, according to their own restrictions. Moreover, the consumer may be called upon to make a mediating assessment as to whether or not they will exchange their attention for one or more specific ads as a way of obtaining compensation that may be used later to consume selected entertainment or information content.

In addition, the advertiser, the information content owner, and the consumer need not know any information regarding the triangular economic transaction beyond the specifics of what they wish to exchange. For example, the advertiser need not know anything about the entertainment or information content they may ultimately pay for. Indeed, the specifics of the entertainment or information content may be unknowable at the time the consumer consumes ads. Further, the information content owner need not know anything about the specifics of any ad, such as its length. Moreover, the consumer need not know the retail price of the desired entertainment or information content, nor the monetary value of any ad directed to their attention.

The presently disclosed systems and methods also make it more practical for the assessments of the advertiser, the information content owner, and the consumer to be made on a per view, per ad, and per consumer basis. As a result, the disclosed systems and methods increase the accuracy of the free-market price determination in the triangular economic transaction, while increasing the likelihood that such a transaction will be consummated. As a result, the information content owner's ability to make money from payments for “actual” rather than “predicted” consumption is enhanced. The advertiser's efficiency is also enhanced by allowing them to pay only the amount demanded by the consumers whose attention they wish to attract, as opposed to some predicted group of consumers. Further, the consumer's experience is enhanced by allowing him or her to have ultimate control over whether and when they exchange their attention for desired entertainment or information content, while providing the consumer with the capability of receiving fewer but more relevant ads.

In one embodiment, a system for delivering and accessing information such as targeted ads and other information content includes at least one advertising content server (the “ad content server”), at least one information content server, at least one consumer computer, and a central system, which performs the functions of an ad/content broker server and a security server. The ad content server, the information content server, and the consumer computer are each communicably coupled to the central system by at least one computer network.

In an exemplary mode of operation, the ad content server provides content for one or more ads, ad bids corresponding to the respective ads, ad targeting criteria, and terms of an advertising campaign to the ad/content broker server within the central system. In one exemplary aspect, an “ad bid” corresponds to the maximum price that an advertiser is willing to offer to a consumer as consideration for consuming (e.g., viewing and/or listening to) ad content corresponding to the ad bid. The consumer can send a request for ads along with authentication credentials from the consumer computer to the ad/content broker server, which verifies the identity of the consumer using the consumer's authentication credentials. Having verified the consumer's identity, the ad/content broker server forwards criteria for local ad matching to the consumer computer based at least in part on the ad targeting criteria provided by the ad content server. The ad/content broker server also forwards to the consumer computer identifiers for the plurality of ads provided by the ad content server. The consumer computer performs local matching of the ad matching criteria against the consumer's personal profile information to generate matching results. Based on those matching results, the consumer computer identifies at least one ad that might be of interest to the consumer from among the plurality of ads provided by the ad content server, and sends the identifier for the identified ad to the ad/content broker server. In response to receiving the identifier for the identified ad, the ad/content broker server forwards ad content for the identified ad along with the corresponding ad bid to the consumer computer. For example, the ad content may contain any type of media, such as audio and video content, audio content only, or video content only.

At any convenient time chosen by the consumer, he or she consumes the ad content provided by the ad/content broker server on the consumer computer, which monitors the consumer's behavior while consuming the ad. The consumer computer also automatically determines how much consumer compensation, if any, is warranted based on the consumer's monitored behavior and the ad bid. Having determined that the consumer's behavior while consuming the ad was adequate to warrant compensation, the consumer computer sends a request for authorization of such compensation to the security server within the central system, which authorizes and effects proper payment of such compensation in the form of electronic credit, crediting an account of the consumer maintained on the consumer computer. The consumer computer also generates and sends ad content consuming behavior data relating to the consumer's behavior while consuming the ad to the ad/content broker server, which generates an electronic invoice based on the terms of the advertising campaign and the ad content consuming behavior data. The ad/content broker server forwards the electronic invoice to the ad content server for payment by the advertiser. In one embodiment, the advertiser remits proper payment of the invoice to the ad/content broker server via the ad content server. In another embodiment, the ad/content broker server is involved in the generation of a physical invoice, which is subsequently forwarded to the advertiser for payment.

In this exemplary mode of operation, the information content server provides content for specific information and/or a uniform resource locator (URL) for the specific information content, and terms of sale for such content including the price of the content, to the ad/content broker server. For example, the substance of the content provided by the information content server may include a movie, a television program, a song, a magazine, a newspaper article, a research report, etc. In one exemplary aspect, the consumer, using the consumer computer, visits a website associated with the information content owner, and makes a selection of desired content for subsequent consumption from among the information content provided by the information content server. In view of the need to pay for the selected information content, the consumer sends a request for authorization of payment for the selected information content from the consumer computer to the security server, which authorizes and effects proper payment of the selected content, debiting an appropriate amount of credit from the consumer's account maintained on the consumer computer. The security server also creates and forwards a digital ticket to the consumer computer for use in enabling the consumer's access of the selected content from the information content server.

At any convenient time chosen by the consumer, he or she accesses the selected information content from the information content server using the consumer computer, which sends the digital ticket provided by the security server to the information content server. In response to receipt of the digital ticket, the information content server forwards the selected information content to the consumer computer for consumption by the consumer. The consumer computer monitors the consumer's behavior while consuming (e.g., viewing and/or listening to) the selected information content, generates information content consuming behavior data based on the consumer's monitored behavior, and sends the information content consuming behavior data to the ad/content broker server. At some interval, the ad/content broker server effects proper payment for the selected information content to the information content owner via the information content server, based on the terms of sale for the content and the consumer's aggregate content consuming behavior data.

By establishing a triangular economic transaction in which information content owners can effectively negotiate sales of their content in transactions involving both advertisers and consumers, the efficiency of services provided by the advertisers can be increased, while the economics of the information content owners is enhanced. For example, via such triangular economic transactions, advertisers can target their ads more accurately and efficiently to consumers based on the consumers' behavior while using their computers, and can set the price they are willing to offer to the consumers for consuming the targeted ads. In addition, information content owners can receive their desired price per consumer for consumption of their content, while offering the content to consumers through their own or others' websites, all according to their own terms of sale for the content. Triangular economic transactions involving information content owners, advertisers, and consumers are enabled and facilitated by a central system, which enhances the content viewing experience of the consumers by allowing them to select one or more ads from among a number of targeted ads for viewing, and to view the selected ads and/or desired information content at their computers or other computerized devices on their own schedules while maintaining a desired level of on-line privacy with regard to their personal information, without at anytime requiring them to view any specific advertisements.

Other features, functions, and aspects of the invention will be evident from the Detailed Description of the Invention that follows.

### BRIEF DESCRIPTION OF THE SEVERAL VIEWS OF THE DRAWINGS

The invention will be more fully understood with reference to the following Detailed Description of the Invention in conjunction with the drawings of which:

FIG. 1 is a diagram illustrating a triangular economic transaction enabling negotiated transactions involving an information content owner, an advertiser, and a consumer, according to the present invention;

FIG. 2 is a block diagram of an exemplary system for implementing the triangular economic transaction of FIG. 1;

FIG. 3 is a block diagram of a consumer computer included in the system of FIG. 2;

FIG. 4 is a block diagram of another exemplary system for implementing the triangular economic transaction of FIG. 1, in which the functions of matching advertisement targeting criteria against the consumer's personal profile information, and determining compensation due to the consumer for consuming (e.g., viewing and/or listening to) advertisements, can be distributed among and performed locally at one or more consumer computers;

FIGS. 5a-5b depict a ladder diagram illustrating exemplary interactions between an advertising content server, the consumer computer, and a central system included in the system of FIG. 4, operating according to the triangular economic transaction of FIG. 1;

FIG. 6 depicts a ladder diagram illustrating exemplary interactions between an information content server, the consumer computer, and the central system included in the system of FIG. 4, operating according to the triangular economic transaction of FIG. 1;

FIG. 7a is an illustration of a screen shot of the consumer computer of FIG. 3, operating in an information content consuming mode;

FIG. 7b is an illustration of a screen shot of the consumer computer of FIG. 3, operating in an ad content consuming mode;

FIG. 7c is another view of the screen shot of FIG. 7b, in which the consumer computer of FIG. 3 operates in the ad content consuming mode;

FIG. 8 is a diagram illustrating an exemplary partial matching technique of the system of FIG. 4;

FIGS. 9a-9b depict a flow diagram illustrating an exemplary method of sequential targeting of ads using the system of FIG. 4; and

FIG. 10 depicts a ladder diagram illustrating exemplary interactions between the information content server, the consumer computer, and the central system included in the system of FIG. 4, operating according to the triangular economic transaction of FIG. 1, in which price discrimination is incorporated into the terms of sale for desired information content.

### DETAILED DESCRIPTION OF THE INVENTION

A system and method of delivering and accessing content such as targeted advertisement content (the “ad content”) and information content in a computer network environment is disclosed that increases the efficiency of services provided by advertisers, while enhancing the economics of information content owners. The presently disclosed system and method can be used to implement a so-called “triangular economic transaction” in which the information content owners can effectively negotiate sales of their content in transactions involving both the advertisers and content consumers.

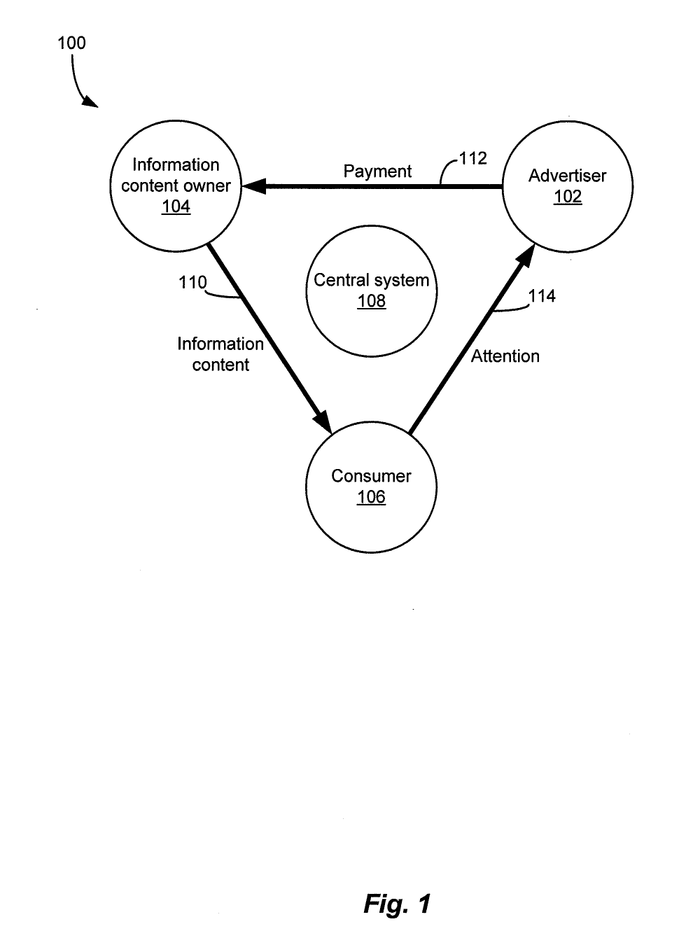

FIG. 1 depicts an illustrative representation of a triangular economic transaction 100 enabling negotiated transactions involving an advertiser 102, an information content owner 104, and a consumer 106, in accordance with the present invention. In the triangular economic transaction 100, each of the advertiser 102, the information content owner 104, and the consumer 106 has an associated computer or other computerized device through which he or she can interact with the other parties to the transactions. The transactions involving the advertiser 102, the information content owner 104, and the consumer 106 are enabled and facilitated by a central system 108, which is communicably coupled to the computers and/or computerized devices of the respective parties to the transactions by at least one computer network. While the transactions involving the advertiser 102, the information content owner 104, and the consumer 106 take place, the advertiser 102 is in control over terms of its advertising campaign, and the information content owner 104 is in control over terms of sale for its content. Moreover, the consumer 106 is in control over which ads and/or information content he or she views, while maintaining control over his or her personal profile information upon which the targeting of ads provided by the advertiser 102 is at least partially based.

As shown in FIG. 1, the advertiser 102, the information content owner 104, and the consumer 106 can communicate with one another over at least three pathways 110, 112, 114 in the computer network. Using the network pathways 110, 112, 114, one of the parties to the triangular economic transaction 100 can offer a product or service of value to another party to the transaction, in return for some form of electronic payment from the remaining party to the transaction. For example, the information content owner 104 can offer information content of value to the consumer 106 over the network pathway 110 in return for proper payment of the offered content originating from the advertiser 102 over the network pathway 112. The advertiser 102 may be willing to provide such payment to the information content owner 104 in response to specific behavior data received from the consumer 106 over the network pathway 114, indicating amounts of time and attention expended by the consumer 106 while consuming (e.g., viewing and/or listening to) ads provided by the advertiser 102. Accordingly, a successful triangular economic transaction calls for the mutual concurrence and cooperation of all three parties to the transaction, namely, the advertiser 102, the information content owner 104, and the consumer 106.

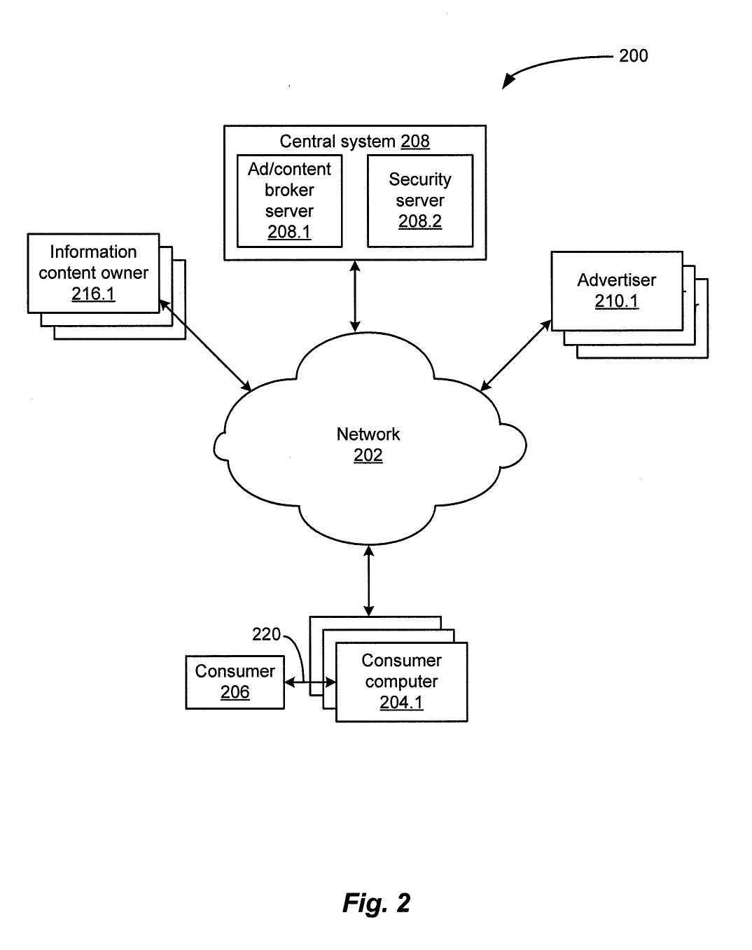

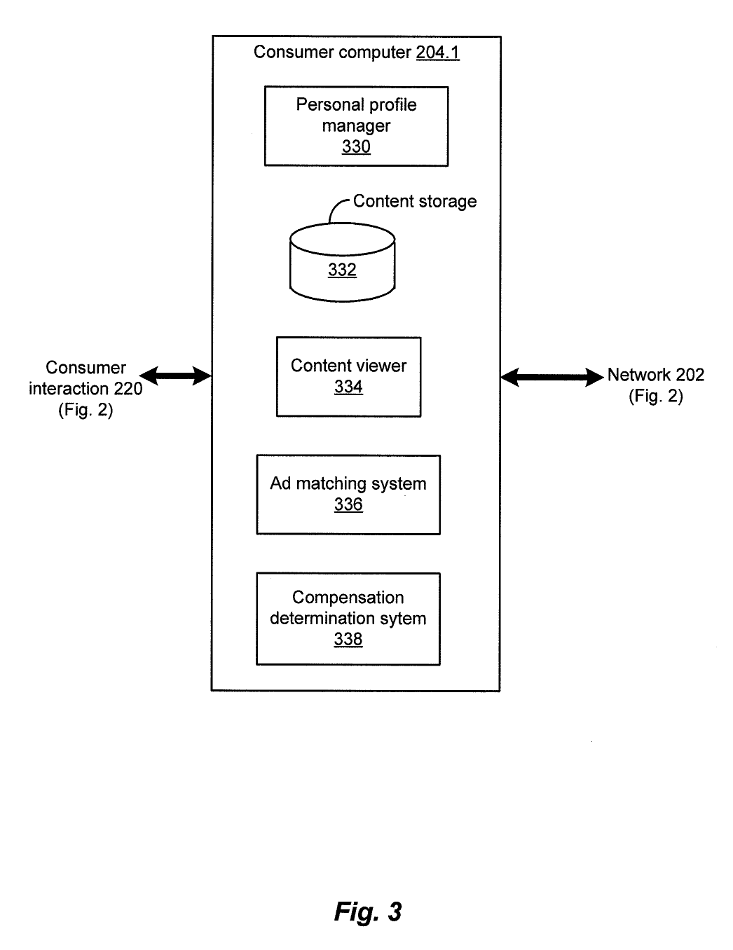

FIG. 2 depicts an exemplary distributed, networked system 200 for implementing the triangular economic transaction 100 of FIG. 1. As shown in FIG. 2, the system 200 includes one or more advertising content server computers (the “ad content servers”) 210.1, 210.2, . . . , 210.m, one or more information content server computers (the “information content servers”) 216.1, 216.2, . . . , 216.n, one or more consumer computers 204.1, 204.2, . . . , 204.p, and a central system 208 including an ad/content broker server computer 208.1 (the “ad/content broker server”) and a security server computer (the “security server”) 208.2, which communicate over a computer network 202. The ad/content broker server 208.1 is operative to enable transactions involving the ad content servers 210.1-210.m, the information content servers 216.1-216.n, and the consumer computers 204.1-204.p. Further, the security server 208.2 is operative to authorize and effect compensation to and payments from consumer accounts maintained on the respective consumer computers 204.1-204.p.

As shown in FIG. 2, each set of computers 210.1-210.m, 216.1-216.n, and 204.1-204.p in the system 200 is communicably connected to the computer network 202. For example, the computer network 202 may include a wireless or wired private network such as a local area network (LAN) or a wide area network (WAN), a public network such as the Internet, a cable television (CATV) distribution network, a wide area telephone or data network, or any other suitable network. In addition, each of the ad content servers 210.1-210.m and the information content servers 216.1-216.n can be implemented using one or more server computers or any other suitable type of computer or computerized device. Further, each of the consumer computers 204.1-204.p can be implemented using a personal computer (PC), a television-connected set top box (TV-STB), a personal video recorder (PVR), a Smartphone, a personal digital assistant (PDA), a home gateway device, a media extender, or any other suitable type of computer or computerized device.

FIG. 3 depicts a number of functional components that can be included in the consumer computer 204.1 of FIG. 2. It is noted that each of the other consumer computers 204.2-p of FIG. 2 can include the functional components depicted in the consumer computer 204.1. As shown in FIG. 3, the consumer computer 204.1 includes a personal profile manager 330, content storage 332 such as a hard or optical disk, and a content viewer 334. The personal profile manager 330 is operative to create and locally maintain personal profile information of a consumer 206 (see FIG. 2) associated with the consumer computer 204.1. For example, the consumer's personal profile information may contain data relating to the consumer's hometown, gender, birth date, ethnicity, religion, education, profession, income level, marital status, hobbies, past consuming behavior, preferences and interests, etc., for use in targeting ads that may be relevant to the background, preferences, and/or interests of the consumer 206. The content storage 332 is operative to store ad content targeted to the consumer 206, and any other information content accessed by the consumer 206. The content viewer 334 is operative to enable and facilitate the consumer's consumption of the ad content and other desired information content.

As shown in FIG. 3, the consumer computer 204.1 further includes an ad matching system 336 and a compensation determination system 338. The ad matching system 336 is operative to perform local matching of ad matching criteria provided by the ad/content broker server 208.1 (see FIG. 2) against the consumer's personal profile information to generate matching results, which are subsequently used to identify at least one ad that might be of interest to the consumer 206. The compensation determination system 338 is operative to make a local determination of how much compensation to the consumer 206 would be warranted for consuming the identified ad. The consumer computer 204.1 is positioned in a content stream between the consumer 206 and the computer network 202, allowing the consumer computer 204.1 to observe all interactions 220 of the consumer 206 with the various computers and other computerized devices connected to the computer network 202. Because each of the consumer computers 204.1-204.p can include the same functional components, including the ad matching system 336 and the compensation determination system 338, the functions of matching the ad matching criteria against the consumer's personal profile information, and determining how much compensation to the consumer is warranted for consuming identified ads, can be distributed among and performed locally at one or more of the respective computers 204.1-204.p.

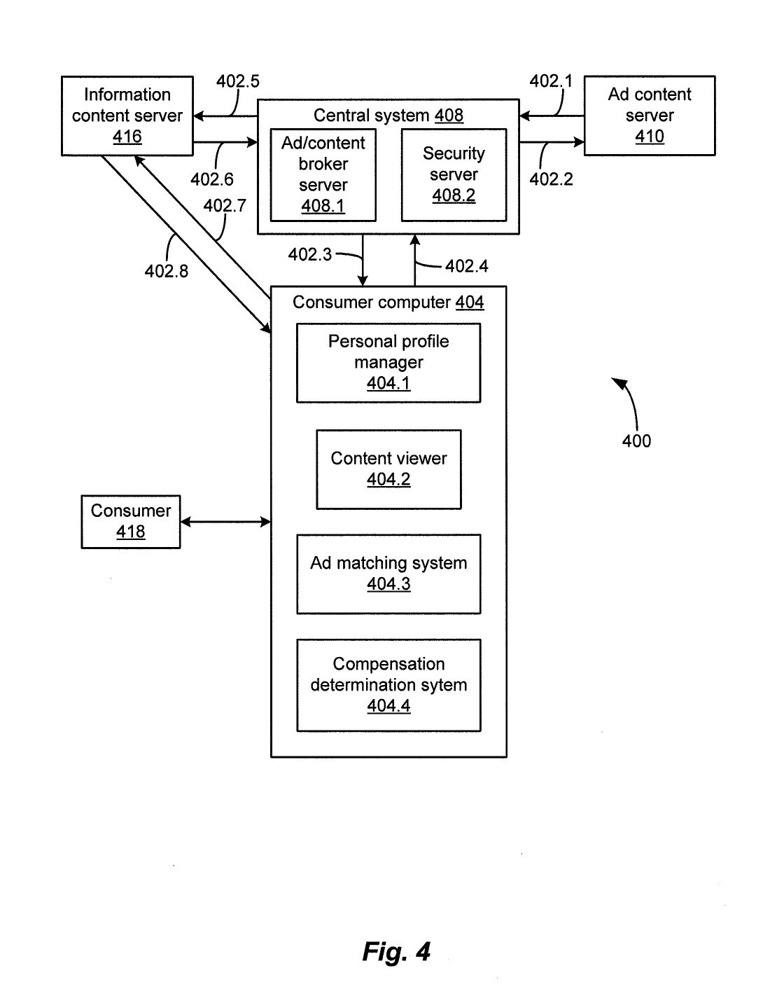

FIG. 4 depicts an exemplary view of another distributed, networked system 400 for implementing the triangular economic transaction 100 of FIG. 1. As shown in FIG. 4, the system 400 includes an ad content server 410, an information content server 416, a consumer computer 404, and a central system 408, which includes an ad/content broker server 408.1 and a security server 408.2. Like the consumer computer 204.1 (see FIGS. 2 and 3), the consumer computer 404 includes a number of functional components including a personal profile manager 404.1, a content viewer 404.2, an ad matching system 404.3, and a compensation determination system 404.4. The ad content server 410, the information content server 416, the consumer computer 404, and the central system 408 are operative to communicate over a plurality of pathways 402.1-402.8 in at least one computer network.

The presently disclosed system for implementing the triangular economic transaction 100 of FIG. 1 will be better understood with reference to the following illustrative example and FIGS. 4, 5a-5b, and 6. In this example, a consumer 418 (see FIG. 4) interacts with the consumer computer 404, such as a PC, to receive, indirectly from the ad content server 410, ad content for a product or service relevant to his or her personal profile. The consumer 418 can also interact with the consumer computer 404, such as the PC, to receive information content including text, images, audio, and/or video contained in a web page, a song, a movie, etc., from the information content server 416.

The consumer computer 404 is positioned in the system 400 between the consumer 418 and the computer network to allow the personal profile manager 404.1 in the consumer computer 404 to observe all of the interactions of the consumer 418 with the various entities connected to the network. Such consumer interactions observed by the personal profile manager 404.1 can include the visiting of web pages, the on-line purchasing of a product or service, the use of a web search engine, the execution of software applications, the sending of e-mail messages, etc. By observing such consumer interactions, the personal profile manager 404.1 can obtain information regarding, for example, the amounts of time the consumer spent viewing certain web pages, how often the consumer visited certain web pages, the types of products or services the consumer purchased over the web, the specific web search terms the consumer used, the types of software applications that were executed on the consumer's computer, the nature of certain e-mail messages the consumer sent, etc. Using at least some of that information, the personal profile manager 404.1 can create a profile of the consumer 418 that includes data indicative of his or her demonstrated preferences and/or interests.

The personal profile manager 404.1 in the consumer computer 404 can also receive information submitted by the consumer 418 via a keyboard or any other suitable input device connectable to the consumer computer 404. For example, the consumer 418 can submit information to the personal profile manager 404.1 relating to his or her hometown, gender, birth date, ethnicity, religion, education, profession, income level, marital status, hobbies, past consuming behavior, specific preferences and interests, etc. In this way, the consumer 418 can explicitly specify and locally manage his or her own personal profile information (e.g., by viewing, editing, adding, and/or deleting selected personal profile data, as desired) to attract ad content that matches his or her background, preferences, and/or interests, while assuring that any sensitive or strictly private information does not become part of the consumer's profile information. The consumer's personal profile information is maintained on the consumer computer 404 so that it is visible to and editable by the consumer 418, and under his or her full and exclusive control.

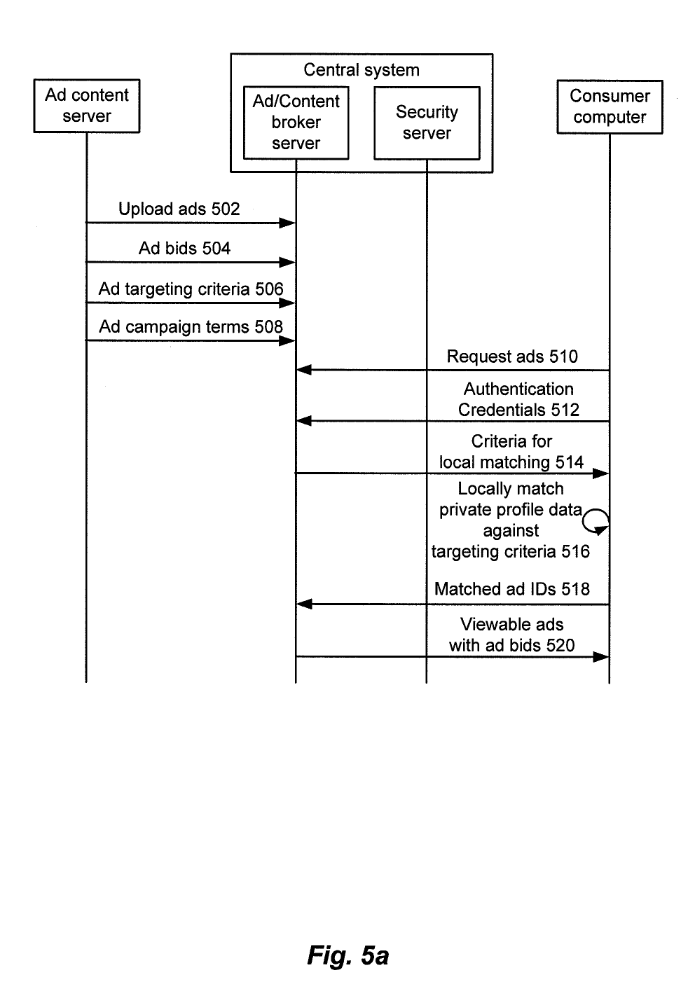

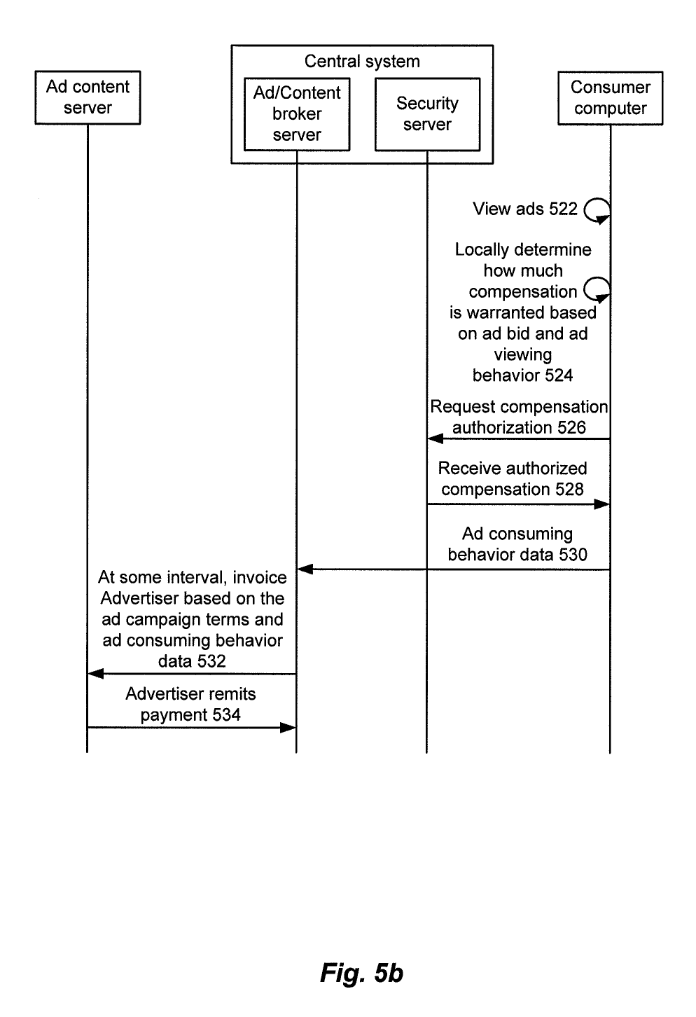

In this example, the advertiser, via the ad content server 410 (see FIG. 4), uploads ad content for a plurality of ads (step 502; see FIG. 5a), along with a plurality of ad bids (step 504), ad targeting criteria (step 506), and terms of an advertising campaign (step 508), to the ad/content broker server 408.1 in the central system 408 over the network pathway 402.1. As employed herein, the term “ad bid” corresponds to the maximum price that an advertiser is willing to offer to a consumer as consideration for fully consuming the ad content associated with the ad bid. For example, the price or “ad bid” that an advertiser is willing to offer targeted individuals for consuming its ad content may be $1.00US per ad, or any other suitable monetary amount. The consumer 418 can send a request for ads (step 510) along with authentication credentials (step 512) over the network pathway 402.4 from the consumer computer 404 to the ad/content broker server 408.1, which verifies the identity of the consumer 418 using the consumer's authentication credentials. For example, the consumer 418 may be motivated to receive and consume (e.g., view and/or listen to) such ads for the purpose of receiving relevant, useful advertisements, and/or to receive compensation for use as possible payment toward past or future consumption of any desired information content. Such payment for desired information content resulting from the consumption of ads is herein referred to as “advertiser-supported” payment, and any payment for desired information content that is not advertiser-supported is herein referred to as “consumer-supported” payment. It is noted that an information content owner may offer potentially desirable information content directly to the consumer 418, effectively acting as an advertiser of the offered content. It is further noted that the ad/content broker server 408.1 may send ad content directly to the consumer computer 404 without the consumer 418 having to send a request for ads to the ad/content broker server 408.1.

Having verified the identify of the consumer 418 using the consumer's authentication credentials, the ad/content broker server 408.1 (see FIG. 4) forwards to the consumer computer 404 over the network pathway 402.3 criteria for localized ad matching (step 514) based at least in part on the ad targeting criteria, which contains data indicative of the possible relevance of an advertised product or service to the consumer 418. The ad/content broker server 408.1 also forwards identifiers for the plurality of ads uploaded by the ad content server 410 to the consumer computer 404 over the network pathway 402.3. Using the ad matching system 404.3, the consumer computer 404 performs local matching of the ad matching criteria against the consumer's personal profile information (step 516) to generate matching results. Based on those matching results, the consumer computer 404 identifies one or more ads that might be of interest to the consumer 418 from among the plurality of ads provided by the ad content server 410, forms a queue of ads (the “ad queue”) potentially of interest to the consumer 418, and sends the identifier for at least one of the ads in the ad queue to the ad/content broker server 408.1 over the network pathway 402.4 (step 518). In response to receiving the identifier for the identified ad, the ad/content broker server 408.1 forwards the ad content for the identified ad along with the associated ad bid to the consumer computer 404 over the network pathway 402.3 (step 520). It is noted that, if no ads of potential interest to the consumer 418 can be identified based on the matching results, then the ad/content broker server 408.1 may forward generic ad content to the consumer computer 404. The ad/content broker server 408.1 may alternatively forward to the consumer computer 404 a reference (e.g., a hyperlink or a uniform resource locator (URL)) that the consumer 418 can use to access either specific or generic ad content over the computer network.

At any convenient time chosen by the consumer 418 (see FIG. 4), he or she consumes (e.g., views and/or listens to) the ad content provided by the ad/content broker server 408.1 using the content viewer 404.2 in the consumer computer 404 (step 522; see FIG. 5b). The content viewer 404.2 is operative to allow the consumer 418 to consume the ad content in an out-of-line fashion, independent of the consumption of any information content (e.g., web pages, songs, movies, etc.). In one embodiment, the consumer 418 can consume the ad content using the consumer computer 404, and the same consumer or a different consumer can consume the information content using a different computer or other computerized device. In this embodiment, the users of the different computers or computerized devices are identifiable by respective user IDs. Moreover, the users' personal profile information remains stored on the respective user computers or computerized devices. In one embodiment, if the same person consumes ad content on one computer or computerized device and consumes desired information content on a different computer or computerized device, then the multiple user computers or computerized devices may operate to synchronize (periodically, if desired) that user's personal profile information across the multiple computers or computerized devices, which may be communicably connected to one another by at least one computer network. It is noted that the content viewer 404.2 can also be configured to prevent the consumption of any ad or information content that is no longer valid or allowed for consumer consumption based on, for example, the passage of a predetermined length of time, and/or the number of times the content has already been consumed.

While the consumer 418 (see FIG. 4) consumes (e.g., views and/or listens to) the ad content provided by the ad/content broker server 408.1, the consumer computer 404 monitors the consumer's behavior. For example, such behavior of the consumer 418 may indicate whether the consumer consumed the ad content completely or just partially, the number of times the consumer consumed the ad content, whether or not the consumer acted (e.g., made an on-line purchase) in response to his or her consumption of the ad content, whether or not the consumer saved the ad content on the consumer computer 404, etc. It is noted that the personal profile manager 404.1 in the consumer computer 404 can automatically and continuously update the consumer's profile information based on the consumer's monitored behavior while consuming the ad content to reflect any observed changes in the consumer's preferences and/or interests. Such automatic and continuous updating of the consumer's profile information can be useful in what is referred to herein as “behavioral targeting” of ads, i.e., the targeting of ads to consumers based on their behavior while consuming ad or other information content.

Using the compensation determination system 404.4 (see FIG. 4), the consumer computer 404 automatically determines how much compensation to the consumer 418 is warranted based on the consumer's monitored behavior while consuming the ad, and the associated ad bid (step 524; see FIG. 5b). Having determined that the consumer's behavior while consuming the ad was adequate to warrant compensation, the consumer computer 404 sends a request for authorization of such compensation to the security server 408.2 in the central system 408 over the network pathway 402.4 (step 526), which authorizes and effects proper payment of such compensation over the network pathway 402.3 (step 528) in the form of electronic credit, crediting an account of the consumer maintained on the consumer computer 404. In addition, the consumer computer 404 generates and sends ad content consuming behavior data relating to the consumer's behavior while consuming the ad to the ad/content broker server 408.1 over the network pathway 402.4 (step 530). Using the consumer's ad content consuming behavior data, the ad/content broker server 408.1 can obtain a measure of the performance of the ad content itself, which may, if desired, influence the ultimate cost of that ad content to the advertiser. The ad/content broker server 408.1 generates an electronic invoice based on the terms of the advertising campaign and the consumer's ad content consuming behavior data, and forwards the electronic invoice to the ad content server 410 over the network pathway 402.2 for payment by the advertiser (step 532), which, in one embodiment, remits proper payment of the invoice to the ad/content broker server 408.1 via the ad content server 410 over the network pathway 402.1 (step 534).

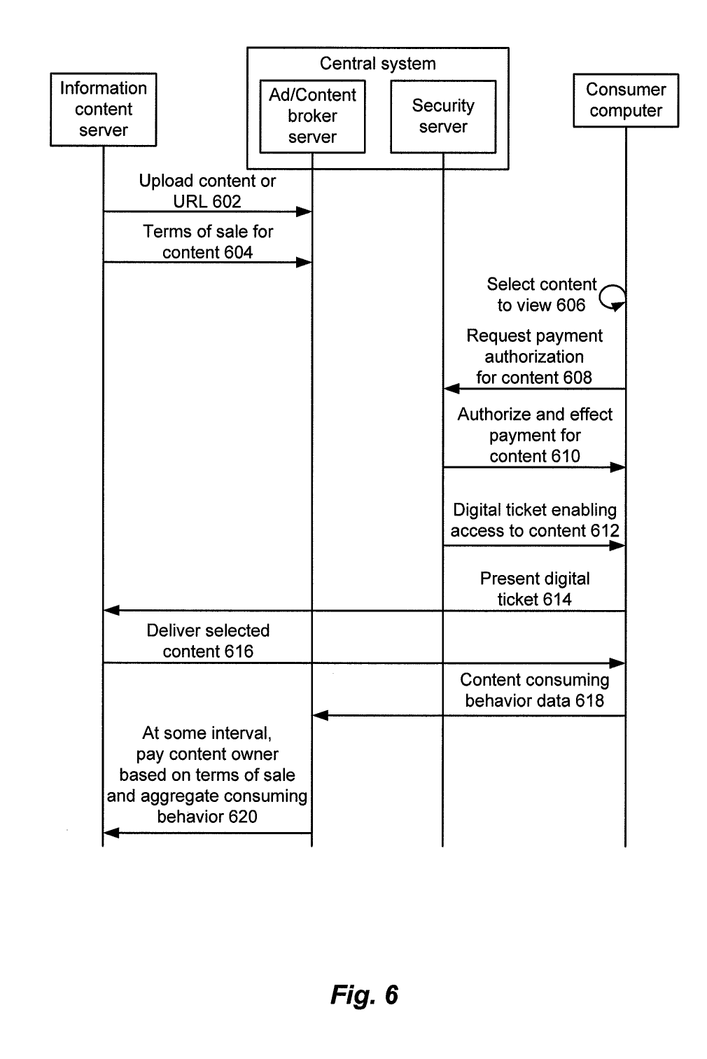

In this example, the information content owner uploads, via the information content server 416 (see FIG. 4), content for specific information (the “information content”) or a URL for the specific information content (step 602; see FIG. 6), and terms of sale for such information content including the price of the content (step 604), to the ad/content broker server 408.1 over the network pathway 402.6. For example, the substance of the information content may include a movie, a television program, a song, a magazine, a newspaper article, a research report, etc. In one embodiment, the consumer 418, using the consumer computer 404, visits a website associated with the information content server 416, and makes a selection of desired information content for subsequent consumption from among the information content uploaded in step 602 (step 606). The consumer 418 sends a request for authorization of payment of the selected information content from the consumer computer 404 to the security server 408.2 over the network pathway 402.4 (step 608), and the security server 408.2 authorizes and effects proper payment of the selected information content over the network pathway 402.3 (step 610) by debiting an appropriate amount of credit from the account of the consumer 418 maintained on the consumer computer 404. In one embodiment, the ad/content broker server 408.1 forwards the electronic invoice to the ad content server 410 in step 532 responsive to the debiting of electronic credit from the consumer's account. The security server 408.2 also forwards a digital ticket to the consumer computer 404 over the network pathway 402.3 for use in enabling the consumer's access of the selected content from the information content server 416 (step 612).

At any convenient time chosen by the consumer 418 (see FIG. 4), he or she accesses the selected information content from the information content server 416 using the consumer computer 404, which sends the digital ticket provided by the security server 408.2 to the information content server 416 over the network pathway 402.7 (step 614; see FIG. 6). In response to receipt of the digital ticket, the information content server 416 forwards the selected information content (e.g., by streaming the content) to the consumer computer 404 over the network pathway 402.8 for consumption by the consumer 418 (step 616). The consumer computer 404 monitors the consumer's behavior while consuming the selected information content, and generates information content consuming behavior data based on the consumer's monitored behavior. For example, the consumer computer 404 can monitor the consumer's behavior while consuming the selected information content to determine whether the consumer consumed the selected information content completely or just partially, the number of times the consumer consumed the selected information content, the order in which the consumer consumed the selected information content or ad content, etc. It is noted that the personal profile manager 404.1 in the consumer computer 404 can automatically and continuously update the consumer's profile information based on the consumer's monitored behavior while consuming the selected information content to reflect any observed changes in the consumer's preferences and/or interests. As discussed above, such automatic and continuous updating of the consumer's profile information can be useful in what is referred to herein as the behavioral targeting of ads.

The consumer computer 404 sends the consumer's information content consuming behavior data to the ad/content broker server 408.1 over the network pathway 402.4 (step 618). Using the consumer's information content consuming behavior data, the ad/content broker server 408.1 can obtain a measure of the performance of the information content itself, which may, if desired, influence the ultimate price that the information content owner is to receive for that information content. At some interval, the ad/content broker server 408.1 effects proper payment for the selected information content to the information content owner, via the information content server 416 over the network pathway 402.5, based on the terms of sale for the respective information content and the consumer's aggregate content consuming behavior data (step 620). It is noted that, in the triangular economic transaction implemented by the system 400, the original source of the funds paid to the information content owner in step 620 can be the advertiser, which, in step 534, remits proper payment to cover the electronic invoice that was previously generated based on the consumer's behavior while consuming ads. Accordingly, in this illustrative example, a successful transaction in the triangular economic transaction can be achieved through the mutual concurrence and cooperation of all three parties to the transaction, namely, the advertiser, the information content owner, and the consumer.

In the illustrative example described above, the consumer 418 (see FIG. 4) consumes ad content delivered by the ad/content broker server 408.1 using the content viewer 404.2 in the consumer computer 404 (see FIG. 5b, step 522). In addition, the information content server 416 forwards information content selected by the consumer 418 to the consumer computer 404 for subsequent consumer consumption using the content viewer 404.2 (see FIG. 6, step 616). In one embodiment, the content viewer 404.2 in the consumer computer 404 is configured to operate in two modes, namely, an information content consuming mode and an ad content consuming mode.

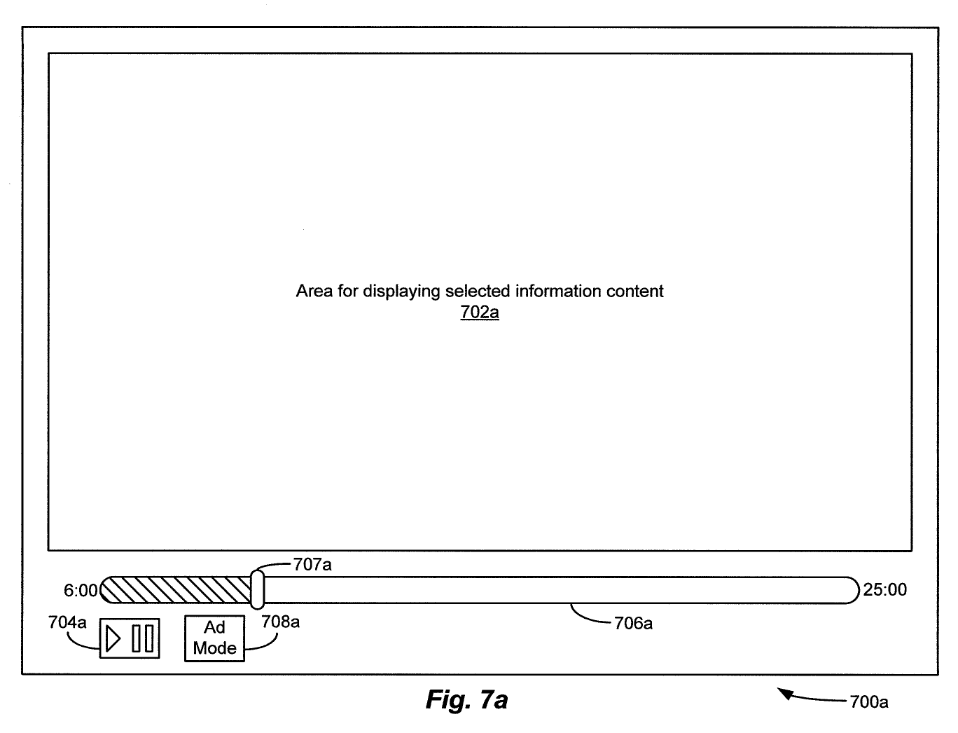

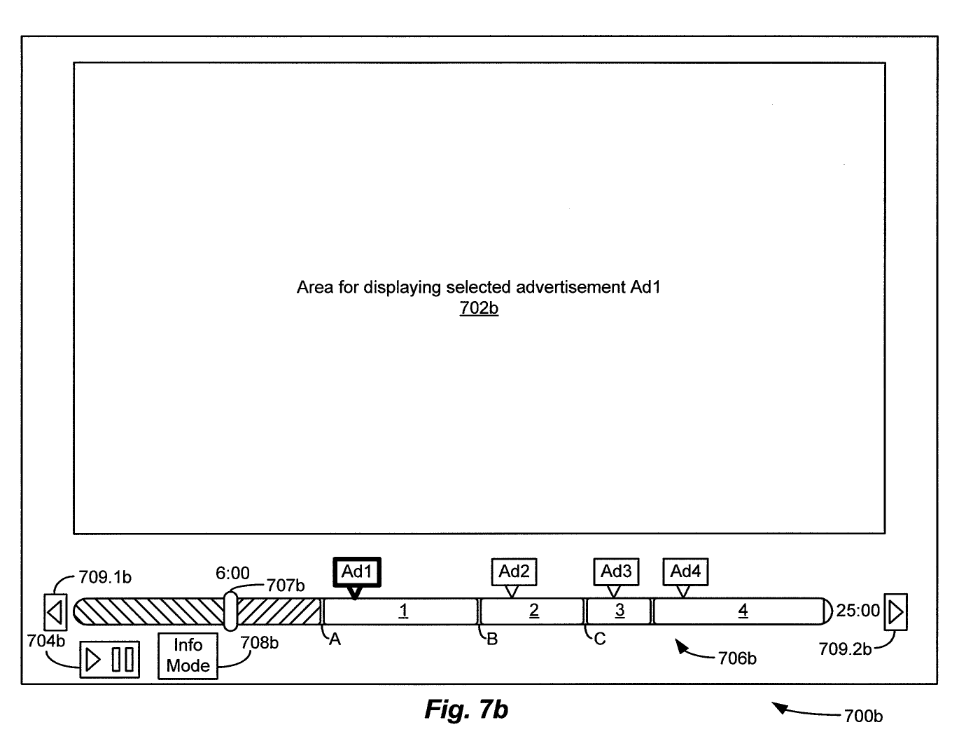

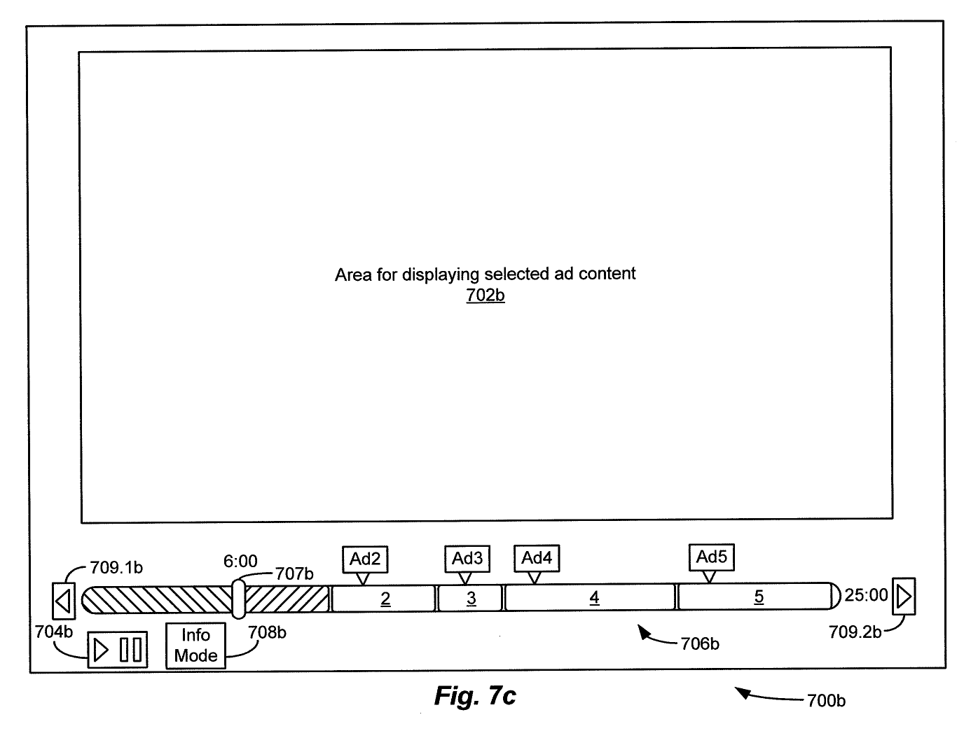

FIG. 7a depicts an exemplary screen shot 700a of a computer display associated with the consumer computer 404 (see FIG. 4), in which the content viewer 404.2 is operating in the information content consuming mode. As shown in FIG. 7a, the screen shot 700a includes a window 702a for displaying selected information content in the form of video or any other suitable display format, and a graphical user interface (GUI) including a play/pause button 704a that a consumer can “click on” for playing the video, using a computer mouse or any other suitable input device, and a progress bar 706a for displaying a representation of the progress of the video as it is being played. For example, in the screen shot 700a of FIG. 7a, the selected video has a total duration of 25:00 minutes, and the progress bar 706a indicates, by way of an indicator 707a (see also FIGS. 7b and 7c, reference numeral 707b), that the window 702a is displaying a portion of the video that is 6:00 minutes into the total video duration.

As described with reference to the illustrative example immediately above, the consumer can consume (e.g., view and/or listen to) ad content based on its value as a possible source of advertiser-supported payment for any information content he or she may wish to consume. To that end, the GUI of FIG. 7a further includes an Ad mode button 708a that the consumer can click on to cause the content viewer 404.2 in the consumer computer 404 to switch operation from the information content consuming mode to an ad content consuming mode, in which the consumer can voluntarily consume one or more ads to earn electronic credit for use as payment for the selected video (or any other suitable type of information content) currently being consumed, or to be consumed at some later time, in the information content consuming mode of the content viewer 404.2.

FIG. 7b depicts an exemplary screen shot 700b of the computer display associated with the consumer computer 404 (see FIG. 4), in which the content viewer 404.2 is operating in the ad content consuming mode. The screen shot 700b includes a window 702b for displaying selected ad content in the form of video or any other suitable format, and a graphical user interface (GUI) including a progress bar 706b for displaying a representation of the progress of the information content currently being consumed, or to be consumed at some later time, in the information content consuming mode of the content viewer 404.2. As shown in FIG. 7b, a plurality of bar segments 1, 2, 3, 4, . . . are overlaid on a portion of the progress bar 706b. Each of the plurality of bar segments 1, 2, 3, 4, . . . corresponds to a different one of the ads in the ad queue formed by the consumer computer during localized ad matching. Each of the different ads is identified by an image Ad1, Ad2, Ad3, Ad4, . . . associated with the bar segments 1, 2, 3, 4, . . . , respectively. The consumer can click on each of the images Ad1, Ad2, Ad3, . . . , using the computer mouse or any other suitable input device, to select the corresponding ad for subsequent consumption via the window 702b.

The GUI of FIG. 7b further includes a play/pause button 704b that the consumer can click on for playing/pausing and consuming (e.g., viewing and/or listening to) the selected advertisement. For example, in the screen shot 700b, the image Ad1 has been clicked on by the consumer, causing the image Ad1 to be highlighted, and causing ad content (e.g., video) corresponding to the selected Ad1 to be selected and displayed in the window 702b for consumption by the consumer. The GUI also includes buttons 709.1b, 709.2b that the consumer can click on to sequentially shift through a series of available ads 1, 2, 3, 4, 5, . . . in the ad queue for possible selection and consumption, and an Info mode button 708b that the consumer can click on to cause the content viewer 404.2 in the consumer computer 404 to switch back to the information content consuming mode to continue consumption of the selected information content.

The functionality of the ad content consuming mode of the consumer computer will be better understood with reference to the following illustrative example and FIGS. 7b and 7c. As shown in FIG. 7b, the progress bar 706b indicates that the selected video (or any other suitable type of information content) currently being consumed, or to be consumed at some later time, in the information content consuming mode of the consumer computer is 6:00 minutes into the total video duration of 25:00 minutes. In this example, the consumer already has enough electronic credit in his or her account to allow him or her to continue consuming the selected video up to position A of the progress bar 706b, at which time the consumer's account on the consumer computer will be depleted of electronic credit. In one embodiment, when the consumer's account becomes depleted of electronic credit, the displaying of the video in the window 702a (see FIG. 7a) in the information content consuming mode will cease. In another embodiment, when the consumer's account is depleted of electronic credit, the video may continue to be displayed in the window 702a, effectively extending a predetermined amount of credit to the consumer. To earn additional electronic credit for use as payment toward continued consumption of the selected video beyond position A of the progress bar 706b, the consumer voluntarily selects and consumes one or more of the ads 1, 2, 3, 4, 5, . . . in the ad queue identified by their associated images Ad1, Ad2, Ad3, Ad4, Ad5, . . . , respectively (see also FIG. 7c).

For example, the consumer may click on the button 709.1b, sequentially shifting the series of available ads 1, 2, 3, 4, 5, . . . in the ad queue to the left, causing the image Ad1 and its corresponding bar segment 1 to disappear from the screen shot 700b, causing the images Ad2, Ad3, Ad4 and their corresponding bar segments 2, 3, 4 to shift one position to the left along the progress bar 706b, and causing the image Ad5 and its corresponding bar segment 5 to be displayed as being overlaid on a portion of the progress bar 706b. The consumer may also click on the button 709.2b to sequentially shift the series of available ads 1, 2, 3, 4, 5, . . . in the queue to the right, causing the image Ad5 and its corresponding bar segment 5 to disappear from the screen shot 700b, causing the images Ad2, Ad3, Ad4 and their corresponding bar segments 2, 3, 4, to shift one position to the right along the progress bar 706b, and causing the image Ad1 and its corresponding bar segment 1 to reappear in the screen shot 700b. In this way, the consumer can shift through all of the available ads 1, 2, 3, 4, 5, . . . in the queue to identify and select, in any desired order, one or more ads of interest for subsequent consumption, skipping any ad or ads that hold little interest to the consumer. In one embodiment, the ad content consuming mode of the consumer computer allows the consumer to change the order of the ads in the ad queue, as desired.

As described above, the bar segments 1, 2, 3, 4, 5, . . . correspond to the series of available ads 1, 2, 3, 4, 5, . . . , respectively. In one embodiment, the length of each of the bar segments 1-5 is representative of the value of the corresponding ad, such that the longer bar segments represent higher value ads, and the shorter bar segments represent lower value ads. Further, in one embodiment, the consumer is not provided with any indications of the actual monetary values of the respective ads. By selecting and consuming one or more of the higher value ads, such as the advertisement Ad1, the consumer may earn a greater number of electronic credit. Alternatively, by selecting and consuming one or more of the lower value ads, such as the advertisement Ad3, the consumer may earn a smaller number of electronic credit. If the consumer's behavior while consuming the selected ads were deemed adequate to warrant compensation, then the consumer's account maintained on the consumer computer would be credited with an amount of electronic credit corresponding to the value of the consumed ads.

For example, if the consumer clicks on the image Ad1 to select the corresponding ad (the “advertisement Ad1”) for consumption, and if the consumer's behavior while viewing the advertisement Ad1 were deemed adequate to warrant compensation, then the consumer's account on the consumer computer would be credited with an amount of electronic credit corresponding to the value of the advertisement Ad1, allowing him or her to continue consuming the selected video or other information content in the information content consuming mode up to position B of the progress bar 706b, at which time the consumer's account would be depleted of credit and the displaying of the video in the window 702a of the information content consuming mode may cease.

Alternatively, if the consumer selects and consumes both the advertisement Ad1 and the advertisement corresponding to the image Ad2 (the “advertisement Ad2”), and if the consumer's behavior while viewing the advertisements Ad1, Ad2 were deemed adequate to warrant compensation, then the consumer's account would be credited with an amount of electronic credit corresponding to the value of both of the advertisements Ad1, Ad2, allowing him or her to continue consuming the selected video or other information content in the information content consuming mode up to position C of the progress bar 706b, at which time the consumer's account will again be depleted of credit and the displaying of the video in the window 702a of the information content consuming mode may again cease. In this way, the consumer can select and consume, in any desired order, any number of available ads of interest to him or her in the ad content consuming mode of the consumer computer, potentially earning an amount of electronic credit corresponding to the value of the respective ads. Such electronic credit earned from consuming ads can be used as advertiser-supported payment for any desired video or other information content currently being consumed, or to be consumed at some later time, in the information content consuming mode of the consumer computer.

Having described the above illustrative embodiments, other alternative embodiments and/or variations to these illustrative embodiments may be made. For example, it was described above that the ad/content broker server in the central system can forward to a consumer computer criteria for localized ad matching based on ad targeting criteria provided by the ad content server. As described herein, the ad targeting criteria contains data indicative of the possible relevance of an advertised product or service to a consumer associated with the consumer computer. It was further described that the consumer computer performs local matching of the ad matching criteria against the consumer's personal profile information to generate matching results, which are used by the consumer computer to identify at least one ad that might be of interest to that consumer. In one embodiment, the consumer computer is operative to perform what is referred to herein as “partial matching” of the local ad matching criteria provided by the ad/content broker server against the consumer's personal profile information.

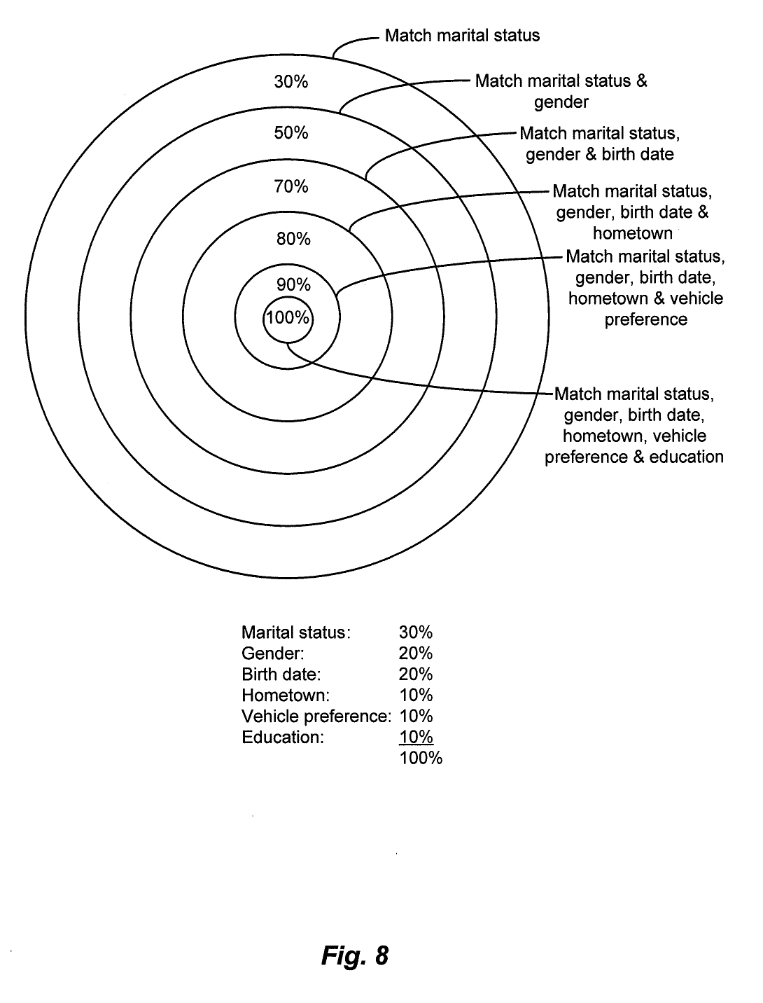

The partial matching of local ad matching criteria against a consumer's personal profile information will be better understood with reference to the following illustrative example and FIGS. 4 and 8. In this example, the local ad matching criteria forwarded to the consumer computer 404 (see FIG. 4) by the ad/content broker server 408.1 targets single women, having birth dates in years ranging from 1970 to 1979, with hometowns in the greater Boston area, who own sports utility vehicles, and have bachelors degrees from all-women's colleges. Further, in this example, the price or “ad bid” that an advertiser is willing to offer those targeted individuals for consuming its ad content is $1.00US per ad. If the consumer computer succeeds in matching all of the specified ad matching criteria (i.e., marital status, gender, birth date, hometown, vehicle preference, and education; see FIG. 8) against the consumer's profile information, then the consumer may earn an amount of electronic credit equivalent to the full one dollar amount of the ad bid for consuming the ad content. However, if, having verified the specified ad matching criteria against the consumer's personal profile information, the consumer computer cannot find matches for all of the specified criteria, then the consumer computer may perform partial matching of the specified criteria against the consumer's personal profile information.

Specifically, while performing partial matching, the consumer computer may determine whether there are any matches for at least part of the local ad matching criteria provided by the ad/content broker server, and, if at least one match is found, allow the consumer to earn electronic credit for consuming ad content equivalent to a specified fraction or percentage of the total ad bid. For example, when the consumer computer performs partial matching of the local ad matching criteria against the consumer's personal profile information, the advertiser may be willing to offer the targeted individuals 30% of the ad bid for matching the marital status criterion, 20% for matching the gender or birth date criterion, and 10% for matching the hometown, vehicle preference, or education criterion.

Accordingly, as depicted in FIG. 8, if the consumer computer does not find matches for all of the specified criteria, but does find a match with regard to the marital status criterion, then he or she may earn an amount of electronic credit equivalent to 30% of the ad bid, or $0.30US, for consuming the advertiser's ad content. Alternatively, if the consumer computer finds matches only with regard to the marital status and gender criteria, then he or she may earn an amount of electronic credit equivalent to 50% (30%+20%) of the ad bid, or $0.50US, for consuming the advertiser's ad content. Further, if the consumer computer finds matches only with regard to the marital status, gender, and birth date criteria, then he or she may earn an amount of electronic credit equivalent to 70% (30%+20%+20%) of the ad bid, or $0.70US, for consuming the advertiser's ad content. Moreover, if the consumer computer finds matches only with regard to the marital status, gender, birth date, and hometown criteria, then he or she may earn an amount of electronic credit equivalent to 80% (30%+20%+20%+10%) of the ad bid, or $0.80US, for consuming the advertiser's ad content.

In addition, if the consumer computer finds matches only with regard to the marital status, gender, birth date, hometown, and vehicle preference criteria, then he or she may earn an amount of electronic credit equivalent to 90% (30%+20%+20%+10%+10%) of the ad bid, or $0.90US, for consuming the advertiser's ad content. However, if the consumer computer finds matches with regard to all of the specified criteria, namely, the marital status, gender, birth date, hometown, vehicle preference, and education criteria, then he or she may earn an amount of electronic credit equivalent to 100% (30%+20%+20%+10%+10%+10%) of the ad bid, or $1.00US, for consuming the advertiser's ad content. Although specific types of ad matching criteria, and specific values for the total ad bid and percentages of the ad bid were employed in the illustrative example of the partial matching technique described above, it will be appreciated that any other suitable type of ad matching criteria, and any other suitable values for the total ad bid and percentages of the ad bid, may be employed. In one embodiment, the amount of electronic credit earned by the consumer may be a function of the degree of the match between a specified ad matching criterion and the consumer's profile information.

It was also described above that the personal profile manager in the consumer computer can automatically and continuously update the consumer's personal profile information based on the consumer's monitored behavior while consuming ad or information content to reflect any observed changes in the consumer's preferences and/or interests. Further, the presently disclosed system can use the updated consumer profile information to perform behavioral targeting of ads, i.e., the targeting of ads to consumers based on their prior behavior while consuming ad or other information content.

One form of behavioral targeting is referred to herein as “simple targeting”, in which the targeting of ads to consumers is performed on a per-consumer computer basis, without regard to the responses of the consumers to any prior advertising campaign, as reflected in their personal profile information. While performing simple targeting of ads, the presently disclosed system can use the updated personal profile information of the consumer to refine the ad targeting criteria provided by the ad content server, so as to identify a specific consumer computer associated with a particular consumer who might be interested in consuming targeted ads. Another form of behavioral targeting is referred to herein as “sequential targeting”, in which a population of consumers is targeted based, at least in part, on their responses to a prior advertising campaign, as reflected in their personal profile information. In one embodiment, such sequential targeting can be performed in an iterative fashion, gradually refining the consumer's personal profile data to more closely reflect a particular consumer's background, preferences, and/or interests. In this way, increasingly more specific targeting of ads to particular consumers can be achieved.

In both simple targeting and sequential targeting, the consumer's computer may incorporate a consumer privacy mechanism that allows the consumer's personal profile information to be matched against ad targeting criteria without conferring any degree of control over the consumer's personal profile data to any other entity. In another embodiment, the above-described central system acts as a trusted third party that performs the functions of the ad/content broker server, and receives, on a temporary basis and under the consumer's control, the consumer's personal profile data for use in satisfying the consumer's desire to receive new and relevant ads. Moreover, via the consumer computer, the consumer can explicitly limit the portions of his or her personal profile data that are used for ad matching. For example, the consumer may block ad matching with regard to his or her financial information, e-mail messages, etc., while allowing queries relating to his or her background, specified preferences and interests, etc. If a trusted third party is allowed temporary access and use of the consumer's personal profile information, then, when that trusted entity is finished using the consumer's profile information, the respective entity permanently deletes all personal information of the consumer from its data storage, leaving no record or copies of the consumer's personal profile data outside of the consumer computer(s) or computerized device(s).

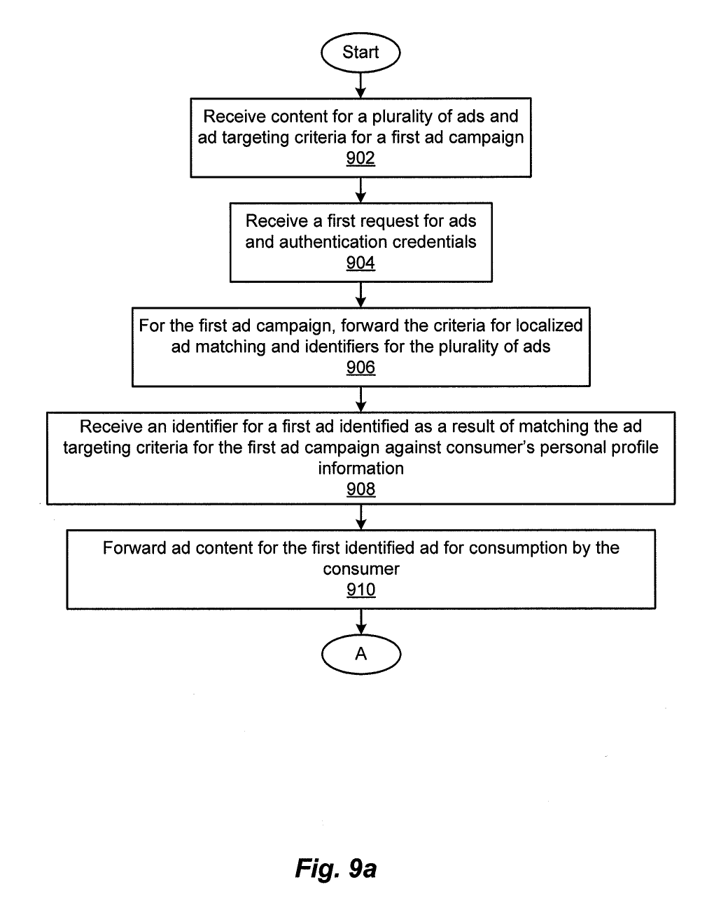

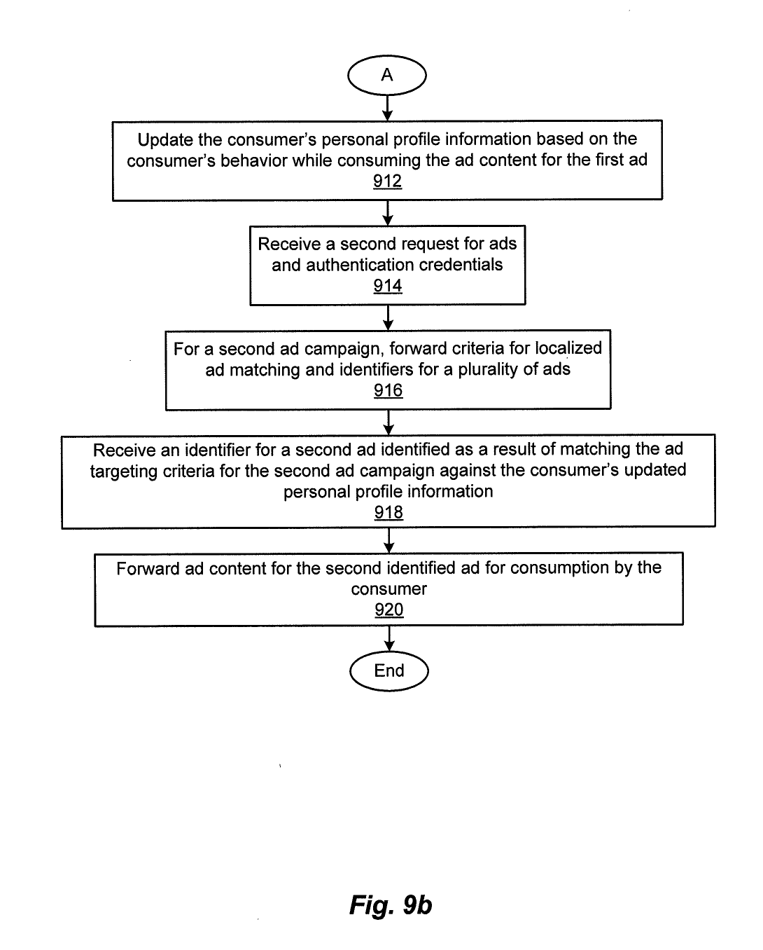

An illustrative method of performing sequential targeting of ads using the presently disclosed system is described below with reference to FIGS. 4 and 9a-9b. As depicted in step 902 (see FIG. 9a), the ad/content broker server 408.1 receives content for a plurality of ads and ad targeting criteria for a first advertising campaign from the ad content server 410 over a computer network. The ad/content broker server 408.1 also receives, over the computer network, a first request for ads and authentication credentials of the consumer 418 associated with the consumer computer 404, as depicted in step 904. Having verified the identity of the consumer 418 using the consumer's authentication credentials, the ad/content broker server 408.1 forwards, over the computer network for receipt at the consumer computer 404, criteria for localized matching based at least in part on the ad targeting criteria for the first advertising campaign, and identifiers for the plurality of ads provided by the ad content server 410, as depicted in step 906. The ad/content broker server 408.1 receives, from the consumer computer 404 over the computer network, an identifier for a first ad that was identified as a result of matching the ad targeting criteria for the first advertising campaign against the consumer's personal profile information, as depicted in step 908. In response to receiving the ad identifier, the ad/content broker server 408.1 forwards the ad content for the first identified ad over the computer network for receipt at the consumer computer 404, as depicted in step 910.

While the consumer 418 consumes (e.g., views and/or listens to) the ad content using the consumer computer 404, the personal profile manager 404.1 automatically and continuously updates the consumer's personal profile information based on the consumer's monitored behavior while consuming the first ad, thereby reflecting the consumer's reaction to the first ad and any new observations with regard to the consumer's preferences and/or interests, as depicted in step 912 (see FIG. 9b). Additionally, the ad/content broker server 408.1 receives content for a plurality of ads and ad targeting criteria for a second advertising campaign from the ad content server 410 over the computer network. As depicted in step 914, the ad/content broker server 408.1 also receives, over the computer network, a second request for ads and the authentication credentials of the consumer 418. Having again verified the identity of the consumer 418 using the consumer's authentication credentials, the ad/content broker server 408.1 forwards, over the computer network for receipt at the consumer computer 404, criteria for localized matching based at least in part on the ad targeting criteria for the second advertising campaign, and identifiers for the plurality of ads of the second advertising campaign, as depicted in step 916. The ad/content broker server 408.1 receives, from the consumer computer 404 over the computer network, an identifier for a second ad that was identified as a result of matching the ad targeting criteria for the second advertising campaign against the consumer's updated personal profile information, as depicted in step 918. In response to receiving the ad identifier, the ad/content broker server 408.1 forwards the ad content for the second identified ad over the computer network for receipt at the consumer computer 404, as depicted in step 920. Because the ad content provided to the consumer computer 404 in step 920 corresponds to an ad identified as a result of matching the ad targeting criteria for the second advertising campaign against the consumer's updated personal profile information, more specific targeting of ads to that particular consumer is achieved. In this way, consumers can be targeted based, at least in part, on the way they reacted to a sequence of earlier ads.

In addition, it was described above that the consumer computer includes a content storage component for storing ad content targeted to the consumer and any other information content targeted to or desired by the consumer. In one embodiment, the consumer may consume one or both of the ad content and the desired information content in real-time, obviating the need to store all of the ad content or information content in the content storage. For example, the consumer may view, in real-time, a television program using his or her television-connected set top box (TV-STB), while ad content is provided to and stored on his or her personal computer (PC) for subsequent consumption. Alternatively, the consumer may consume both the ad content and the information content in real-time, without storing any of the ad or information content in the content storage.

In addition, the consumer may be associated with multiple consumer computers and/or computerized devices, and may choose to consume ads on one computer or device to earn electronic credit for use in paying for desired information content via a different computer or device. For example, the consumer's consumption of the ad content on his or her PC may earn electronic credit that the consumer can use to pay for the consumption of television programming using the TV-STB.

In addition, it was described above that the consumer can receive compensation for consuming ads via the security server, which authorizes and effects payment of such compensation over the network in the form of electronic credit, crediting the consumer's account maintained on the consumer computer. In alternative embodiments, the consumer can redeem such electronic credit for items other than information content, such as frequent flier miles, loyalty points, on-line services or subscriptions, off-line goods, services or programs, monetary currency, or any other suitable item.

It was also described above that, in a triangular economic transaction, the information content owner can offer information content of value to the consumer over a network. In alternative embodiments, the offered information content may be pay-per-view content, pre-paid ad-supported video-on-demand (VOD) content, time-limited rental content, subscription content, or any other suitable type of content. Further, pricing terms for such content may incorporate price discrimination, making the price a function of geographical location, time, the targeted consumer's past behavior, the degree to which the ad targeting criteria matches the consumer's personal profile information, etc.

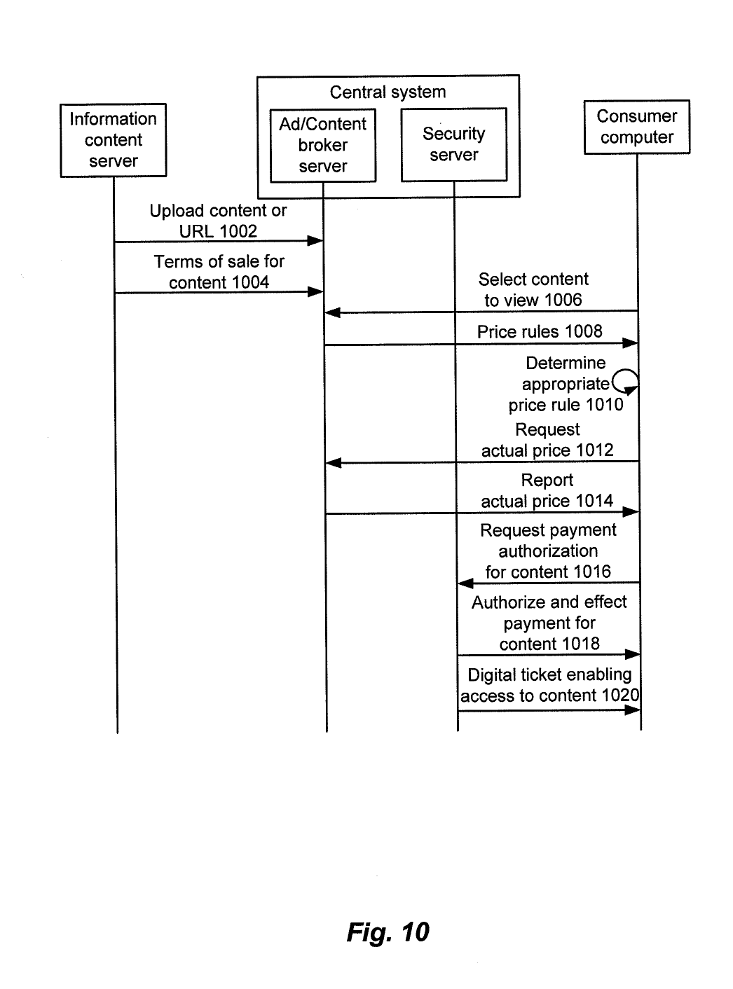

In the presently disclosed system, the incorporation of price discrimination into the terms of sale for desired information content will be better understood with reference to the following illustrative example and FIGS. 4, 6, and 10. In this example, the information content owner uploads, via the information content server 416 (see FIG. 4), content for specific information (the “information content”) or a URL for the information content (step 1002; see FIG. 10), and terms of sale for such information content including a number of price rules based on geographical location, time, the targeted consumer's past behavior, the degree to which the ad targeting criteria matches the consumer's personal profile information, etc., to the ad/content broker server 408.1 (step 1004). For example, the substance of the information content may include a movie, a television program, a song, a magazine, a newspaper article, a research report, etc. The consumer 418 makes a selection of desired information content for subsequent consumption (step 1006). In one embodiment, the consumer 418, using the consumer computer 404, visits a website containing a URL to the information content owner's content, and makes a selection of desired information content that corresponds to information content uploaded to the ad/content broker server 408.1 in step 1002. Responsive to the consumer's selection of desired information content, the ad/content broker server 408.1 sends the price rules to the consumer computer 404 (step 1008), which automatically determines and selects the most appropriate price rule based on the consumer's personal profile information (1010). The consumer computer 404 sends a request for the actual price of the selected information content, based on the match between the selected price rule and the consumer's personal profile information, to the ad/content broker server 408.1 (step 1012), which reports the actual price of the selected information content to the consumer computer 404 (step 1014). The consumer 418 sends a request for authorization of payment of the selected information content from the consumer computer 404 to the security server 408.2 (step 1016), and the security server 408.2 authorizes and effects proper payment of the selected information content (step 1018), debiting an amount of credit corresponding to the actual price of the selected information content from the account of the consumer 418 maintained on the consumer computer 404. The security server 408.2 also forwards a digital ticket to the consumer computer 404 for use in enabling the consumer's access of the selected information content from the information content server 416 (step 1020). The consumer 418 can then use the digital ticket provided in step 1020 to access the selected information content from the information content server 416, and generate content consuming behavior data for the ad/content broker server 408.1, in accordance with steps 614, 616, 618, and 620 of FIG. 6.

In addition, it was described above that the security server can forward a digital ticket to the consumer computer over a network for use in enabling the consumer's access of selected content from the information content server over the network. In alternative embodiments, a physical ticket or coupon may be issued to the consumer for use in accessing or obtaining any desired entertainment, information, goods, or services over any suitable computer or communications network, or via any suitable physical delivery method.

In addition, it was described above that, in a triangular economic transaction, an information content owner may offer information content of value to a consumer in return for proper payment of the offered content originating from an advertiser. Further, the advertiser may be willing to provide such payment in response to specific behavior data received from the consumer, indicating amounts of time and attention expended by the consumer while consuming ads provided by the advertiser. In one embodiment, an operator of the central system, which enables and facilitates the transactions involving the advertiser, the information content owner, and the consumer, can earn commissions based at least in part on the value of the transaction. For example, the operator of the central system may earn, as a commission, a predetermined fraction or percentage of the monetary amounts paid to the information content owners by the advertisers for the information content purchased by the consumer. It should be appreciated that the central system described hereinabove can implement any suitable compensation arrangement between the consumer, the advertisers, and the information content owners. Such compensation arrangements may be based at least in part upon the consumer's personal profile information, the consumer's content consuming behavior data, and/or any other suitable information relating to the consumer's consumption of ad content and/or information content.

It should also be appreciated that each consumer computer, each ad content server, each information content server, and the central system including the ad/content broker server and the security server, may be embodied as a single computer system or as separate computer sub-systems, each including one or more processors, program code memory, an operating system, application software, and one or more network interfaces for transmitting and/or receiving data and/or multimedia content over at least one computer network. Such a system arrangement allows the functions of matching the ad matching criteria against the consumer's personal profile information, and determining how much consumer compensation is warranted for consuming ads, to be performed locally at a single consumer computer, or in a distributed fashion at multiple consumer computers. Such a system arrangement also allows the matching and/or compensation determination functions to be performed at the remote central system, or in a distributed fashion at the central system and one or more consumer computers. If the central system is allowed temporary access and use of the consumer's personal profile information while performing any of the matching and/or compensation determination functions, then, when the central system is finished using the consumer's profile information, the central system permanently deletes all personal information of the consumer from its data storage, leaving no record or copies of the consumer's personal profile data outside of the consumer computer(s) or computerized device(s).

It will be further appreciated by those of ordinary skill in the art that further modifications to and variations of the above-described method and system for processing on-line transactions involving a content owner, an advertiser, and a targeted consumer may be made without departing from the inventive concepts disclosed herein. Accordingly, the invention should not be viewed as limited except as by the scope and spirit of the appended claims.

What is claimed is:

1. A system for processing a transaction involving an information content provider, an ad content provider, and a consumer over at least one computer network, said information content provider being associated with an information content server, said ad content provider being associated with an ad content server, and said consumer being associated with at least one consumer computer, said system comprising:
at least one memory; and
at least one processor operative to execute at least one computer program out of said at least one memory:
to receive, over said at least one computer network, first terms associated with compensation to be paid to said consumer by said ad content provider upon consumption of ad content by said consumer;
to receive, over said at least one computer network, second terms associated with compensation to be paid to said information content provider upon consumption of information content by said consumer;
to receive, over said at least one computer network, an indication that said consumer has satisfied said first terms;
responsive to said indication that said consumer has satisfied said first terms, to forward, over said at least one computer network, an electronic invoice for a first payment amount for receipt at said ad content server, said first payment amount to be remitted by said ad content provider for use, at least in part, in connection with said compensation to be paid to said consumer;
to receive, over said at least one computer network, an indication that said consumer has satisfied said second terms; and
responsive to said indication that said consumer has satisfied said second terms, to forward, over said at least one computer network, an electronic payment for a second payment amount for receipt at said information content server, said second payment being forwarded as said compensation to be paid to said information content provider.

2. The system of claim 1 wherein said at least one processor is further operative to execute said at least one computer program out of said at least one memory:
to receive said ad content over said at least one computer network; and
to receive, over said at least one computer network, a request for said ad content initiated by said consumer associated with said at least one consumer computer.

3. The system of claim 2 wherein said at least one processor is further operative to execute said at least one computer program out of said at least one memory to receive, over said at least one computer network, authentication credentials for use in identifying said consumer initiating said request for said ad content.

4. The system of claim 2 wherein said at least one processor is further operative to execute said at least one computer program out of said at least one memory:
responsive to receipt of said request for said ad content, to forward ad targeting criteria over said at least one computer network for receipt at said at least one consumer computer;
to receive, over said at least one computer network, results of matching said ad targeting criteria against consumer profile information associated with said consumer; and
to forward, over said at least one computer network, said ad content for receipt at said at least one consumer computer based on said results of said matching of said ad targeting criteria against said consumer profile information.

5. The system of claim 4 wherein said at least one processor is further operative to execute said at least one computer program out of said at least one memory to forward, over said at least one computer network, said ad content and an indication of a price associated with said ad content for receipt at said at least one consumer computer.

6. The system of claim 1 wherein said at least one processor is further operative to execute said at least one computer program out of said at least one memory to receive, over said at least one computer network, a request for authorization of said compensation to be paid to said consumer, said request being initiated by said consumer associated with said at least one consumer computer.

7. The system of claim 6 wherein said at least one processor is further operative to execute said at least one computer program out of said at least one memory, responsive to receipt of said request for said authorization of said compensation to be paid to said consumer, to forward said authorization of said compensation to be paid to said consumer over said at least one computer network for receipt at said at least one consumer computer.

8. The system of claim 6 wherein said at least one processor is further operative to execute said at least one computer program out of said at least one memory, responsive to receipt of said request for said authorization of said compensation to be paid to said consumer, to forward electronic credit over said at least one computer network for receipt at an account of said consumer maintained in association with said at least one consumer computer.

9. The system of claim 1 wherein said at least one processor is further operative to execute said at least one computer program out of said at least one memory:
to receive, over said at least one computer network, behavior-based feedback relating to the consumption of said ad content by said consumer at said at least one consumer computer; and
to forward, over said at least one computer network, said electronic invoice for said first payment amount based at least in part on said behavior-based feedback relating to the consumption of said ad content by said consumer.

10. The system of claim 1 wherein said at least one processor is further operative to execute said at least one computer program out of said at least one memory to receive, over said at least one computer network, electronic remittance of said first payment amount.

11. The system of claim 1 wherein said at least one processor is further operative to execute said at least one computer program out of said at least one memory to receive, over said at least one computer network, a request for authorization of said compensation to be paid to said information content provider, said request being initiated by said consumer associated with said at least one consumer computer.

12. The system of claim 11 wherein said at least one processor is further operative to execute said at least one computer program out of said at least one memory, responsive to receipt of said request for said authorization of said compensation to be paid to said information content provider, to forward said authorization of said compensation to be paid to said information content provider over said at least one computer network for receipt at said at least one consumer computer.

13. The system of claim 11 wherein said at least one processor is further operative to execute said at least one computer program out of said at least one memory, responsive to receipt of said request for said authorization of said compensation to be paid to said information content provider, to receive electronic credit corresponding to said compensation to be paid to said information content provider over said at least one computer network.

14. The system of claim 11 wherein said at least one processor is further operative to execute said at least one computer program out of said at least one memory, responsive to receipt of said request for said authorization of said compensation to be paid to said information content provider, to forward a digital ticket over said at least one computer network for receipt at said at least one consumer computer, said digital ticket for use by said consumer associated with said at least one consumer computer for enabling access to said information content over said at least one computer network.

15. The system of claim 1 wherein said at least one processor is further operative to execute said at least one computer program out of said at least one memory:
to receive, over said at least one computer network, behavior-based feedback relating to the consumption of said information content by said consumer at said at least one consumer computer; and
to forward, over said at least one computer network, said electronic payment for said second payment amount based at least in part of said behavior-based feedback relating to the consumption of said information content by said consumer at said at least one consumer computer.

16. The system of claim 1 wherein said information content is selected from the group consisting of pay per view content, pre-paid ad-supported video-on-demand (VOD) content, time-limited rental content, and subscription-based content.

17. A system for receiving ad content and information content over at least one computer network, comprising:
at least one consumer computer associated with at least one consumer, said at least one consumer computer including:
at least one memory; and
at least one processor operative to execute at least one computer program out of said at least one memory:
to receive said ad content over said at least one computer network;
to provide a first output containing said ad content for consumption by said at least one consumer;
to receive, over said at least one computer network, compensation for the consumption of said ad content by said at least one consumer;
to forward, over said at least one computer network for receipt at at least one first server computer, a request for authorization to use said compensation as electronic payment for said information content, said request being initiated by said at least one consumer associated with said at least one consumer computer;
to receive, over said at least one computer network, said authorization to use said compensation as said electronic payment and a digital ticket for enabling access to said information content;
to forward said digital ticket over said at least one computer network for receipt at a second server computer; and
in response to having forwarded said digital ticket, to receive said information content over said at least one computer network.

18. The system of claim 17 wherein said at least one processor is further operative to execute said at least one computer program out of said at least one memory:
to forward a request for said ad content over said at least one computer network for receipt at said first server computer, said request being initiated by said at least one consumer associated with said at least one consumer computer; and
in response to having forwarded said request for said ad content, to receive ad targeting criteria over said at least one computer network.

19. The system of claim 18 wherein said at least one processor is further operative to execute said at least one computer program out of said at least one memory to forward, over said at least one computer network for receipt at said first server computer, authentication credentials for use in identifying said at least one consumer initiating said request for said ad content.

20. The system of claim 18 wherein said at least one processor is further operative to execute said at least one computer program out of said at least one memory to match said ad targeting criteria against consumer profile information associated with said at least one consumer to generate matching results.

21. The system of claim 20 wherein said at least one processor is further operative to execute said at least one computer program out of said at least one memory:
to forward said matching results over said at least one computer network for receipt at said first server computer; and
to receive said ad content over said at least one computer network based on said matching results.

22. The system of claim 17 further including a first consumer computer and a second consumer computer,
wherein said first consumer computer includes at least one memory, and at least one processor operative to execute at least one computer program out of said at least one memory:
to forward a request for said ad content over said at least one computer network for receipt at said first server computer, said request being initiated by said at least one consumer associated with said first consumer computer;
in response to having forwarded said request for said ad content, to receive ad targeting criteria over said at least one computer network;
to match said ad targeting criteria against consumer profile information associated with said at least one consumer to generate matching results; and
to forward said matching results over said at least one computer network for receipt at said first server computer, and
wherein said second consumer computer includes at least one memory, and at least one processor operative to execute at least one computer program out of said at least one memory:
to receive said ad content over said at least one computer network based on said matching results.

23. The system of claim 17 wherein said at least one processor is further operative to execute said at least one computer program out of said at least one memory:
to receive, over said at least one computer network, an indication of a price associated with said ad content; and
to forward, over said at least one computer network for receipt at said first server computer, said request for authorization to use said compensation as said electronic payment based on said price associated with said ad content.

24. The system of claim 23 wherein said price is determined responsive to processing at least one rule.

25. The system of claim 17 wherein said at least one processor is further operative to execute said at least one computer program out of said at least one memory:
to receive, over said at least one computer network, a plurality of rules for determining an actual price of said ad content;
to determine an appropriate rule from among said plurality of rules for determining said actual price of said ad content;
to forward, over said at least one computer network for receipt at said first server computer, a request for said actual price of said ad content based on processing said appropriate rule, said request being initiated by said at least one consumer associated with said at least one consumer computer;
to receive, over said at least one computer network, said actual price of said ad content; and
to forward, over said at least one computer network for receipt at said first server computer, said request for authorization to use said compensation as said electronic payment based on said actual price of said ad content.

26. The system of claim 23 wherein said at least one processor is further operative to execute said at least one computer program out of said at least one memory:
to monitor behavior of said at least one consumer while consuming said ad content; and
to locally determine an amount of said compensation based at least in part on one or more of said price associated with said ad content and said behavior of said at least one consumer while consuming said ad content.

27. The system of claim 26 wherein said at least one processor is further operative to execute said at least one computer program out of said at least one memory to forward, over said at least one computer network for receipt at said first server computer, a request for authorization of said amount of said compensation, said request being initiated by said at least one consumer associated with said at least one consumer computer.

28. The system of claim 17 wherein said information content is selected from the group consisting of pay per view content, pre-paid ad-supported video-on-demand (VOD) content, time-limited rental content, and subscription-based content.

29. The system of claim 17 further including a first consumer computer and a second consumer computer,
wherein said ad content and said compensation for the consumption of said ad content are received at said first consumer computer, and
wherein said information content is received at said second consumer computer.

30. A system for receiving targeted content over at least one computer network, comprising:
at least one memory; and
at least one processor operative to execute at least one computer program out of said at least one memory:
to receive a plurality of content targeting criteria over said at least one computer network;
to match said plurality of content targeting criteria against consumer profile information to generate matching results, said matching results being indicative of one or more successful matches between a portion of said plurality of content targeting criteria and said consumer profile information;
to forward, over said at least one computer network, said matching results for receipt at at least one server computer;
in response, at least in part, to having forwarded said matching results, to receive, over said at least one computer network, targeted content for consumption by at least one consumer, said targeted content being based, at least in part, on said matching results; and
to receive, over said at least one computer network, an amount of compensation for the consumption of said targeted content by said at least one consumer, said amount of compensation being based, at least one part, on said portion of said plurality of content targeting criteria successfully matching said consumer profile information.

31. The system of claim 30 wherein said at least one processor is further operative to execute said at least one computer program out of said at least one memory to receive, over said at least one computer network, an indication of a payment amount associated with the consumption of said targeted content by said at least one consumer.

32. The system of claim 31 wherein said amount of compensation corresponds to a specified percentage of said payment amount, said specified percentage being based, at least in part, on said portion of said plurality of content targeting criteria successfully matching said consumer profile information.

33. The system of claim 31 wherein said plurality of content targeting criteria correspond to a plurality of types of content targeting criteria, and wherein said specified percentage of said payment amount is based, at least in part, on the types of said portion of said plurality of content targeting criteria successfully matching said consumer profile information.

34. The system of claim 30 wherein said amount of compensation is a function of a degree of matching between at least one respective content targeting criterion and said consumer profile information.

35. A system for receiving ad content and information content over at least one computer network, comprising:
at least one memory; and
at least one processor operative to execute at least one computer program out of said at least one memory:
to forward, over said at least one computer network for receipt at a first server computer, a request for first ad content, said request being initiated by a consumer;
in response to having forwarded said request for said first ad content, to receive first ad targeting criteria over said at least one computer network;
to match said first ad targeting criteria against consumer profile information associated with said consumer to generate first matching results;
to forward said first matching results over said at least one computer network for receipt at said first server computer;
to receive said first ad content over said at least one computer network based on said first matching results;
to monitor behavior of said consumer while consuming said first ad content;
to update said consumer profile information based on the monitored behavior of said consumer; and
to receive second ad content over said at least one computer network, said second ad content being based on results of matching second ad targeting criteria against the updated consumer profile information.

36. The system of claim 35 wherein said at least one processor is further operative to execute said at least one computer program out of said at least one memory:
to forward, over said at least one computer network for receipt at said first server computer, a request for said second ad content, said request being initiated by said consumer;
in response to having forwarded said request for said second ad content, to receive said second ad targeting criteria over said at least one computer network;
to match said second ad targeting criteria against the updated consumer profile information associated with said consumer to generate second matching results;
to forward said second matching results over said at least one computer network for receipt at said first server computer; and
to receive said second ad content over said at least one computer network based on said second matching results.

37. A system for displaying information content and one or more ad content items to a consumer, each of said information content and said one or more ad content items having an associated value, said information content further having an associated duration, said system comprising:
at least one display;
at least one memory; and
at least one processor operative to execute at least one computer program out of said at least one memory:
in response to an input selection from said consumer, to selectively display, on said at least one display, said information content or said one or more ad content items for consumption by said consumer;
to display, on said at least one display, a first visual representation of said information content, said first visual representation having a first dimension representative of said value or said duration of said information content;
to display, on said at least one display, one or more second visual representations corresponding to one or more respective ad content items, each of said one or more second visual representations having a second dimension representative of said value of the respective ad content item, said second dimension being less than said first dimension and being representative of a portion of said information content that said consumer would be entitled to consume if the respective ad content item were consumed by said consumer; and
to display, on said at least one display, said one or more second visual representations in association with said first visual representation to graphically display a relationship between said value of each respective ad content item and said value or said duration of said information content.

38. The system of claim 37 wherein said at least one processor is further operative to execute said at least one computer program out of said at least one memory, responsive to the consumption of one of said one or more ad content items by said consumer, to enable, on said at least one display, the display of said portion of said information content for consumption by said consumer, said portion of said information content having a duration corresponding to said value of the respective ad content item consumed by said consumer.

39. A method of processing a transaction involving an information content provider, an ad content provider, and a consumer over at least one computer network, said information content provider being associated with an information content server, said ad content provider being associated with an ad content server, and said consumer being associated with at least one consumer computer, said method comprising the steps of:
receiving, over said at least one computer network, first terms associated with compensation to be paid to said consumer by said ad content provider upon consumption of ad content by said consumer;
receiving, over said at least one computer network, second terms associated with compensation to be paid to said information content provider upon consumption of information content by said consumer;
receiving, over said at least one computer network, an indication that said consumer has satisfied said first terms;
responsive to the receipt of said indication that said consumer has satisfied said first terms, forwarding, over said at least one computer network, an electronic invoice for a first payment amount for receipt at said ad content server, said first payment amount to be remitted by said ad content provider, at least in part, as said compensation to be paid to said consumer;
receiving, over said at least one computer network, an indication that said consumer has satisfied said second terms; and
responsive to the receipt of said indication that said consumer has satisfied said second terms, forwarding, over said at least one computer network, an electronic payment for a second payment amount for receipt at said information content server, said second payment being forwarded as said compensation to be paid to said information content provider.

40. A method of receiving ad content and information content over at least one computer network, comprising the steps of:
receiving said ad content over said at least one computer network;
providing a first output containing said ad content for consumption by at least one consumer;
receiving, over said at least one computer network, compensation for the consumption of said ad content by said at least one consumer;
forwarding, over said at least one computer network for receipt at a first server computer, a request initiated by said at least one consumer for authorization to use said compensation as electronic payment for said information content;
receiving, over said at least one computer network, said authorization to use said compensation as said electronic payment and a digital ticket for enabling access to said information content;
forwarding, over said at least one computer network for receipt at a second server computer, said digital ticket to access said information content; and
receiving said information content over said at least one computer network.

41. A method of receiving targeted content over at least one computer network, comprising the steps of:
receiving a plurality of content targeting criteria over said at least one computer network;
matching said plurality of content targeting criteria against consumer profile information to generate matching results, said matching results being indicative of one or more successful matches between a portion of said plurality of content targeting criteria and said consumer profile information;
forwarding, over said at least one computer network, said matching results for receipt at at least one server computer;
in response, at least in part, to said forwarding of said matching results, receiving, over said at least one computer network, targeted content based, at least in part, on said matching results for consumption by at least one consumer; and
receiving, over said at least one computer network, an amount of compensation for the consumption of said targeted content by said at least one consumer, said amount of compensation being based, at least one part, on said portion of said plurality of content targeting criteria successfully matching said consumer profile information.

42. A method of receiving ad content and information content over at least one computer network, comprising the steps of:
forwarding, over said at least one computer network for receipt at a first server computer, a request initiated by a consumer for first ad content;
in response to said forwarding of said request for said first ad content, receiving first ad targeting criteria over said at least one computer network;
locally matching said first ad targeting criteria against consumer profile information associated with said consumer to generate first matching results;
forwarding said first matching results over said at least one computer network for receipt at said first server computer;
receiving said first ad content over said at least one computer network based on said first matching results;
monitoring behavior of said consumer while consuming said first ad content; and
updating said consumer profile information based on the monitored behavior of said consumer.

43. The method of claim 36 further including:
forwarding, over said at least one computer network for receipt at said first server computer, a request initiated by a consumer for second ad content;
in response to said forwarding of said request for said second ad content, receiving second ad targeting criteria over said at least one computer network;
locally matching said second ad targeting criteria against the updated consumer profile information associated with said consumer to generate second matching results;
forwarding said second matching results over said at least one computer network for receipt at said first server computer; and
receiving said second ad content over said at least one computer network based on said second matching results.

44. A method of displaying information content and one or more ad content items to a consumer, each of said information content and said one or more ad content items having an associated value, said information content further having an associated duration, said method comprising the steps of:
in response to an input selection from said consumer, selectively displaying, on said at least one display, said information content or said one or more ad content items for consumption by said consumer;
displaying, on said at least one display, a first visual representation of said information content, said first visual representation having a first dimension representative of said value or said duration of said information content;
displaying, on said at least one display, one or more second visual representations corresponding to one or more respective ad content items, each of said one or more second visual representations having a second dimension representative of said value of the respective ad content item, said second dimension being less than said first dimension and being representative of a portion of said information content that said consumer would be entitled to consume if the respective ad content item were consumed by said consumer; and
displaying, on said at least one display, said one or more second visual representations in association with said first visual representation to graphically display a relationship between said value of each respective ad content item and said value or said duration of said information content.
